(19) United States
(12) Patent Application Publication
(10) Pub. No.: US 2015/0339762 A1
(43) Pub. Date: Nov. 26, 2015

(54) Systems and Methods for Generating an Online Solar Energy Marketplace

(71) Applicant: GEOSTELLAR, INC., Marthinsburg, WV (US)

(72) Inventors: Richard B. DEAL, Shenandoah Junction, WV (US); Russell B. DAWE, Shenandoah Junction, WV (US); Jeremy T. DOBRZANSKI, Shepherdstown, WV (US); David A. LEVINE, Shepherdstown, WV (US); Mark C. WIRT, Shepherdstown, WV (US)

(21) Appl. No.: 14/716,454

(22) Filed: May 19, 2015

Related U.S. Application Data
(60) Provisional application No. 62/000,366, filed on May 19, 2014.

(51) Int. Cl. G06Q 30/06; G06Q 50/06; G06Q 30/02

(52) U.S. Cl. CPC G06Q 30/0641; G06Q 30/0283; G06Q 50/06

(57) ABSTRACT

Computer-implemented systems and methods are disclosed for providing an online solar marketplace. In an embodiment, a geolocation may be received corresponding to a property. Available equipment, installation, and financing offerings may be retrieved from a marketplace repository. The marketplace repository may store a plurality of service and equipment offerings from one or more equipment providers, installation providers, or financing providers. An integrated solar energy offering may be generated based on the retrieved equipment, installation or financing offerings, and a solar energy simulation may be performed for the solar energy offering to estimate energy production over a predetermined time period. The solar energy offering and energy production estimates may then be presented to a user of the solar marketplace.

### CROSS-REFERENCE TO RELATED APPLICATIONS

The present application claims the benefit of U.S. Provisional Patent Application No. 62/000,366, filed on May 19, 2014, which is incorporated herein by reference in its entirety.

### BACKGROUND

1. Technical Field

The technical field relates to solar energy.

2. Background

Conventional electricity from utility companies is predominant among consumers due to predictable costs and ease of installation. Renewable energy options, such as solar energy systems, present many challenges to consumers that prevent widespread adoption. For example, energy production from a renewable energy system may vary with environmental conditions, unlike conventional electricity, and thus energy costs become more difficult to predict. Costs of equipment and installation for solar energy systems may also vary significantly by vendor, requiring the average consumer to understand the dynamics of the renewable energy market in order to make an informed decision. A solution is needed to provide accurate energy production and cost estimates to consumers while simplifying the process of adopting solar energy.

### SUMMARY

Computer-implemented systems and methods are disclosed for providing an online solar marketplace. In an embodiment, a geolocation may be received corresponding to a property. Available equipment, installation, and/or financing offerings may then be retrieved from a marketplace repository. The marketplace repository may store a plurality of service and equipment offerings from one or more equipment providers, installation providers, or financing providers. An integrated solar energy offering may be generated based on the retrieved equipment, installation, and/or financing offerings. A solar energy simulation may be performed for the solar energy offering to estimate energy production over a predetermined time period. The solar energy offering and energy production estimate may then be presented to a remote user of the online solar marketplace.

In an embodiment, pricing information may also be retrieved from the marketplace repository. A total installed cost for the solar energy offering may then be calculated based on the retrieved pricing information. In an embodiment, the calculated installed cost may be normalized based on a solar array capacity specified in the solar energy offering.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is a diagram illustrating energy providers involved in a solar energy offering, according to an embodiment.

FIG. 2 is a diagram illustrating an example pricing model for a solar energy offering, according to an embodiment.

FIG. 3 is a diagram illustrating an example solar energy simulation on a particular property, according to an embodiment.

FIG. 4 is a diagram illustrating elements that may be altered when running a new solar energy simulation, according to an embodiment.

FIG. 5 is a diagram illustrating interaction between users collaborating on a solar energy simulation, according to an embodiment.

FIG. 6 is a diagram that illustrates two example displays of information on tablet and mobile phone devices based on output from an online energy marketplace according to an embodiment.

FIG. 7 is a diagram illustrating market analysis based on market simulations of particular geopolitical regions, according to an embodiment.

FIG. 8A-8B are example methods for presenting a solar energy offering to a user of a solar energy marketplace, according to an embodiment.

FIG. 9 illustrates an example method for ranking, sorting and analyzing individual properties within a geographic or geopolitical region, according to an embodiment.

FIG. 10 is a diagram illustrating an example system for providing a solar energy marketplace, according to an embodiment.

FIG. 11 is a diagram illustrating an example computing system, according to an embodiment.

FIG. 12A is an example interface for a solar marketplace, according to an embodiment.

FIG. 12B is a map illustrating solar potential of a particular region, according to an embodiment.

FIGS. 12C-12D are example interfaces for viewing details of a solar energy offering, according to an embodiment.

FIGS. 12E-12F are example interfaces for entering and altering parameters of a solar energy simulation, according to an embodiment.

FIG. 12G is an example interface for viewing and monitoring details of a selected solar energy system installation, according to an embodiment.

FIG. 12H is an example interface for viewing estimated energy production of a solar energy system, according to an embodiment.

FIG. 12I is an example interface for displaying the estimated costs of solar energy compared to conventional electricity costs, according to an embodiment.

FIG. 12J is an example interface for communicating among users of an online solar marketplace.

FIG. 13 is an example interface for entering solar energy base pricing information in an online solar marketplace, according to an embodiment.

FIGS. 14A-14B are example interfaces for entering an equipment offering in an online solar marketplace, according to an embodiment.

FIG. 15 is an example interface for entering a financing offering in an online solar marketplace, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

### Example Online Solar Energy Marketplace

In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The value of a solar energy system offering on a particular rooftop is a function of both the levelized cost of energy (LCOS) of the electricity produced by the solar array and the cost of the conventional grid electricity that is displaced. LCOE can differ from rooftop to rooftop with the same equipment configuration due to differing intensity of solar radiation on each rooftop. The LCOE may take into account one or more of the following factors: cost of various equipment configurations, efficiency of various equipment configurations, cost of installation, quality of installation, cost of financing, form of financing, or other factor impacting cost.

In an embodiment, a solar energy marketplace quantifies and compares the potential value of a unique solar energy offering for a particular rooftop, including equipment, installation, and/or financing, by performing simulations of each solar offering on the rooftop. The rooftop may have a unique incidental solar radiation signature based on characteristics such as atmosphere, shade, slope and orientation. The value of each solar energy offering may then be compared against conventional electricity from the power grid.

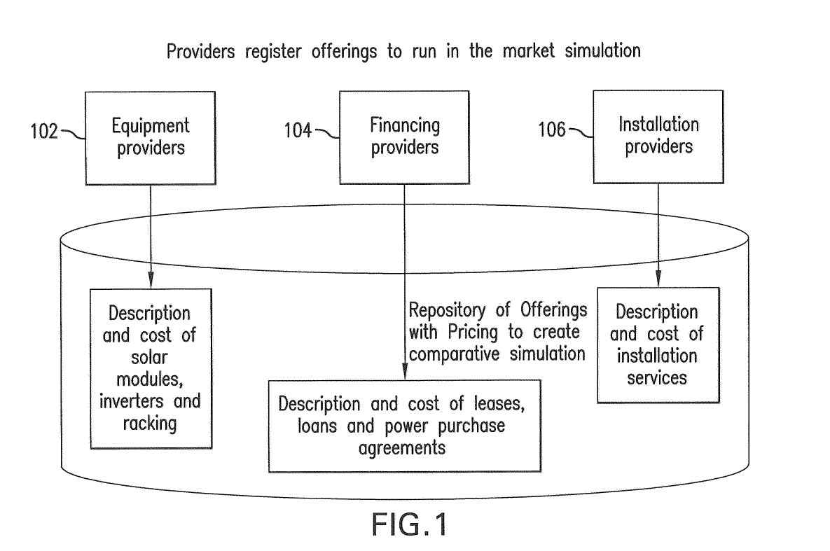

FIG. 1 is a diagram illustrating energy providers involved in a solar energy offering, according to an embodiment. In an embodiment, the solar energy marketplace enables energy providers to input solar energy equipment, installation, and financing offerings. These providers may be categorized by type, for example equipment providers, installation providers, and financing providers.

Equipment providers 102 may be manufacturers or distributors of solar energy equipment. In an embodiment, the equipment provided may include, but is not limited to, solar modules (panels), inverters, racking and mounting systems, and/or balance of system (BoS). Solar modules may produce electrical current from incidental solar radiation. Inverters may convert the electricity produced from direct current (DC) to alternating current (AC) for consumption by businesses or residences. Racking and mounting systems may be used to secure the solar modules to a rooftop. BoS may include cabling, basic installation hardware, and/or other peripherals.

Installation providers 106 (also referred to herein as installers) may provide the following services such as, but not limited to, site verification and assessment, system design, rebate applications, permitting, engineering, and/or planning.

Financing providers 104 (also referred to herein as financing companies) may provide various financing programs for a solar energy offering such as, but not limited to, leases, power purchase agreements (PPAs), and loans. For lease programs, a financing company and associated investors may own, monitor, and maintain the solar energy equipment installed on the roof of a property, receive incentives (e.g., solar energy tax rebates), and charge the property owner a fixed monthly lease amount for the installed solar energy array. The lease payments may be competitively priced to be less than the monthly rate of energy displaced by the array. For PPAs, a financing company and associated investors may monitor and maintain the solar energy equipment installed on the roof of a property, receive incentives, and charge the property owner for the power produced by the solar energy array. The new cost of electricity may again be competitively priced to be less than the cost of energy displaced by the array. For loan agreements, a financing company may lend money to a property owner to acquire and install solar equipment. Interest may be charged on the loan, which again may be priced competitively to be less than the cost of energy displaced by the solar energy array.

In an embodiment, providers may provide offerings in more than one category.

for example, an equipment manufacturer or distributor may offer installation and/or financing, an installer may offer equipment and/or financing, and a financing company may offer equipment and/or installation. In this case, a provider may be included in more than one type category.

Each offering may have different specifications and costs. These may be updated by the provider or by an administrator of the marketplace system.

In an embodiment, an integrated solar energy offering may combine equipment, installation and financing in an authorized combination. Certain financing companies may only provide leases, PPAs and loans for systems that include certain equipment configurations. Equipment companies may also be restricted to only provide equipment to certain authorized installers. Certain installers may represent certain equipment and financing companies.

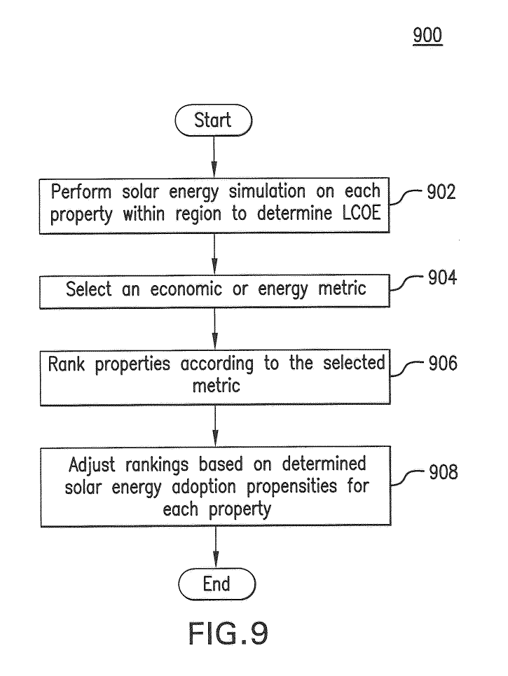

In an embodiment, each provider may price their elements separately, and the marketplace may combine them in an integrated offering. Pricing of offerings may also include a time period for which the offer is valid. Additionally, pricing of offerings may reflect the system size, roof type, and other factors, as described further below. Equipment and service prices may be stored in marketplace repository, such as marketplace repository 940 of FIG. 9, according to an embodiment.

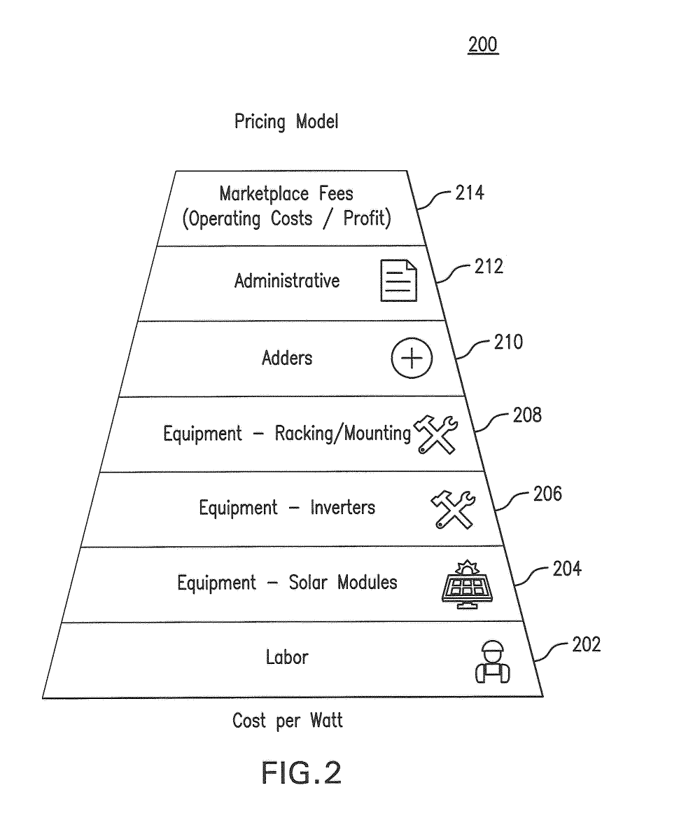

FIG. 2 is a diagram illustrating an example pricing model for a solar energy offering, according to an embodiment. A solar energy offering may include labor costs 202, equipment costs 204-208, adder costs 210, administrative costs 212, and marketplace fees 214. Costs 202 through 214 represent a pricing model for a solar energy offering, according to an embodiment. The total installed cost (e.g., purchasing and installing a solar array as specified in the solar energy offering) may be determined by combining costs 202-214. In an embodiment, the cost of the solar energy offering may be normalized based on solar array capacity (e.g., per Watt) in order to directly compare options involving systems of different size. By allowing multiple providers to participate in the solar energy offering, prices may reflect local or national market rates due to pricing transparency among providers. Without such an online solar marketplace, price discrimination may occur due to a lack of consumer knowledge.

Labor costs 202 may include typical installation costs associated with a solar energy system, such as but not limited to, site verification and assessment, system design, and equipment installation. Equipment costs 204 may be associated with solar modules (panels) included in the system. Equipment costs 206 may be associated with inverters included in the system. Equipment costs 208 may be associated with racking and/or mounting systems to secure the solar modules to a rooftop. Administrative costs 212 may include, but are not limited to, permitting, auditing, and paperwork costs.

In a market where solar energy is less competitive with conventional electricity, for example due to low conventional electricity rates, poor renewable energy incentives, or low insolation (incidental solar radiation), offerings may be priced more competitively. Additionally, a large solar energy system, for example larger than 6 kW, may cost less per Watt than a smaller system due to fixed overhead for setup, logistics, and soft costs that may be incurred. Price may also be reduced through lower cost components, such as polycrystalline modules and string inverters.

An example system might be priced at $1.62 per Watt if the system is purchased for cash. In an embodiment, $0.92 of this cost may be allocated for equipment and $0.70 may be allocated for labor and installation. For an average 6.5 kW system, a total of $10,530 in cash may be paid, with $5,980 going to the equipment provider and $4,550 going to the installer.

In an embodiment, each equipment and installation provider may enter their base price for a standard configuration. Equipment and installation providers may then enter the price of adders 210, which represent additional costs that may be incurred. These may be fixed cost or calculated on a per-Watt basis. Example adders may include, for example, the following:

| Per Watt Adder | Per Watt Charge |
|---|---|
| Monocrystalline modules, which are more efficient | $0.18 |
| Microinverters, which are attached to each panel for | $0.30 |
| module-level monitoring and control | |
| Tile roof (more expensive mounting) | $0.25 |
| Landscape panel orientation | $0.05 |
| High Roof (above 20 ft with no staging area) | $0.05 |
| Steep Roof (30 degrees+, for each 5 degree increment) | $0.05 |
| Ground Mount | $0.65 |
| Tilt-up modules (for flat roof) | $0.05 |
| Mileage (above 50 miles from radius from business) | $0.01 |

Example fixed cost adders may include, for example, the following:

| Fixed Adder | Amount |
|---|---|
| Site verification, assessment and monitor installation | $250 |
| Filing for rebates and incentives | $500 |
| System design, permitting, engineering and plan sets | $700 |
| Subarrays, each additional | $150 |
| Main Breaker Derate | $300 |
| AC Combiner | $400 |
| Relocate circuits to subpanel | $300 |
| Supply Side Tap | $400 |
| Meter Housing Upgrade | $400 |
| 200 A Service Upgrade | $2,000 |
| Feet of Conduit over 100′ | $4.00/ft |
| Ground Mount over 250′ | $17.00/ft |

In an embodiment, promotions may also be created, such that a specific price may be offered for a particular time-period. Descriptions of equipment, and the equipment's suitability for particular environments, may be entered by providers or system administrators, or uploaded directly from a provider's system. Similarly, descriptions of installers may be included to distinguish the capabilities of the installer.

Examples of equipment description fields that may be added may include, but are not limited to, name of equipment manufacturer, model of equipment, brand logo, equipment origination (e.g., country where made), size and/or power of solar module, equipment warranty, and equipment efficiency rating.

Examples of installer description fields that may be added may include, but are not limited to, name of installer, brand logo, company values, company origin, leadership biographies, number of years of solar installation experience, number of completed projects, workmanship warranty, insurance coverage, number of employees, and company revenue.

In an embodiment, the pricing model may take into account additional discounts, rebates, federal incentives, and/or local incentives to reduce the installed cost of the solar energy offering. For example, residential renewable energy tax credits may be taken into account to estimate the installed cost of the solar energy offering.

Once a price for a solar energy offering has been established via the pricing model, financing may be added. For a lease or a PPA, a look-up table of monthly payment rates may be created based on the requirements of the fund, which typically include IRR (internal rate of return) and other factors. From the fund criteria, a look up table may be created with system size, cost, location and production estimates. The lease pricing may be recalculated based on an upfront payment that may be made by the property owner. Loans may be calculated based on the interest, term, and fees associated with the amount that is borrowed.

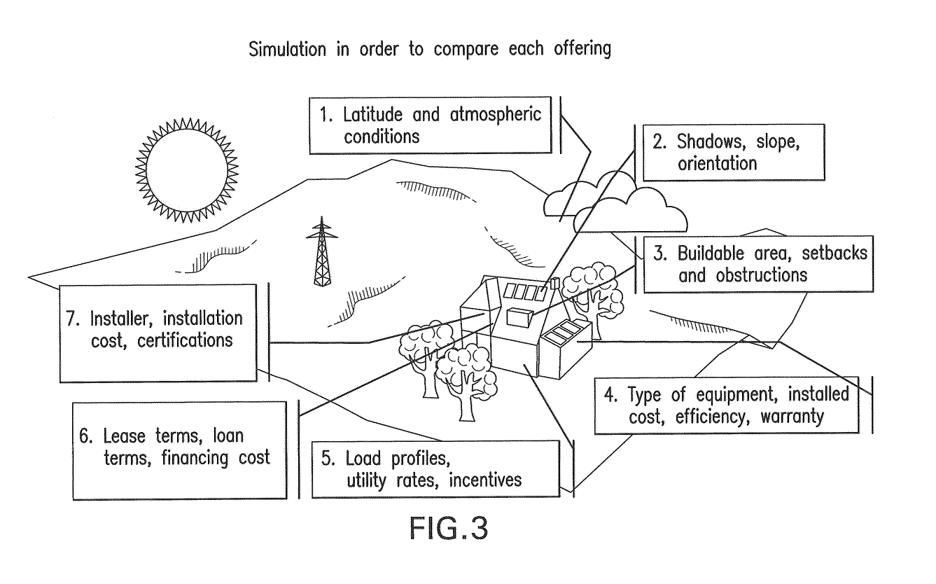

In an embodiment, each offering represents a solar array with a particular performance profile, installed cost, financing program and other characteristics. A solar energy simulation and energy production analysis may be run for each offering on each individual property, as discussed further with respect to FIG. 3. Simulations can be run in bulk on a plurality of properties, or on-demand for a particular property. Additionally, part of the simulation may be run in advance, and the rest on-demand.

For example, the energy production part of the simulation may be performed on every property in a broad region. The results may then be stored in a data repository, such as marketplace repository 940 of FIG. 9. These energy production simulations may be computed based on incidental solar radiation and buildable area of each roof facet. In an embodiment, the cost of the equipment and the financing options may then be computed ad hoc when an address is queried.

FIG. 3 is a diagram illustrating an example solar energy simulation on a particular property, according to an embodiment. The property may be represented by a 3D model, with roof facets that may be extracted using remote sensing technologies, for example, from LiDAR or stereo imagery. Vegetation may also be separated from impermeable surfaces using, for example, LiDAR, color infrared, four-band or multi-spectral imagery.

Detailed installation models and planning may be performed on the virtual property models to produce an optimal system design for best solar performance. These may also be made code compliant, as, in an embodiment, the marketplace may be coupled to a building code database and permitting database via a network, such as the Internet.

When running a simulation, various factors may be taken into account to determine the best design and offering. As illustrated in FIG. 3, these factors may include, but are not limited to, latitude and atmospheric conditions, roof shadows, slope and orientation, buildable area, setbacks, and obstructions, equipment type, installed cost, efficiency, and warranty, load profiles, utility rates, available incentives, lease terms, loan terms, financing costs, and installer certifications. In one embodiment, the design process may be fully automated, with different equipment and financing options being fit to the 3D property model, or scene, and each option being compared, for example by a genetic algorithm, to determine the best system design is available.

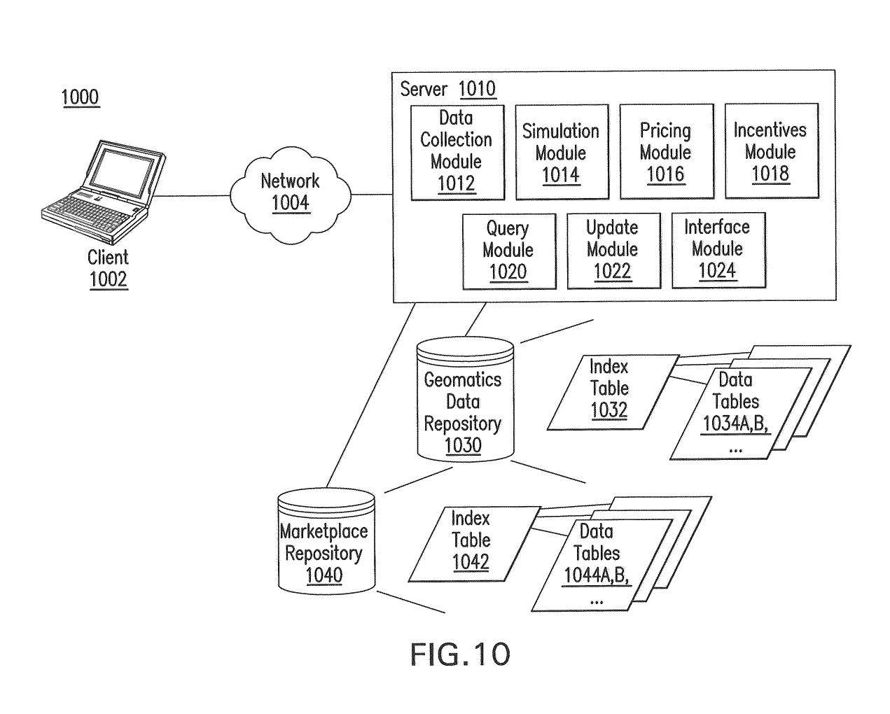

In another embodiment, a property scene may be constructed from ground-level photographs taken from a consumer mobile device or GPS-enabled camera. In this embodiment, a user may use a mobile device with location systems and camera to take photographs of roof installation sites and surrounding areas from multiple ground location points. Dimensional estimations may be performed by a computing device, such as the computing system of FIG. 10, and augmented with manual input from the user.

In both embodiments, a 3D scene model that includes elevation and positional data for both the site of the solar array and surrounding area may be reconstructed. In various embodiments, the user may select the desired roof or ground surface, facet or facets for solar installation, or this may be determined by the system based on available incidental solar radiation. The system may arrange the components of the solar array, or they may be manipulated by the user. Permitting and code compliance may be validated and enforced in the 3D model. These may include setbacks from the edges of the roof, resistance to wind and support under the weight of snow. In an embodiment, permitting and code compliance values may be available in the system through an API.

Equipment elements such as racking, mounting, size and efficiency of panels and efficiency of inverters may be used to determine specific performance, which may be optimized in the simulation. In an embodiment, a full plan-set for installation may be output to a user device.

In an embodiment, the system design may be overlaid on the photographs. The system design may also be presented in augmented reality systems, for example GOOGLE GLASS, for use by installers. The presentation may also be viewed by the property owner as an overlay in a photograph or superimposed on the roof through the augmented reality system. Further details of data collection and property construction are described in U.S. patent application Ser. No. 13/117,419, filed May 27, 2011, which is incorporated by reference herein in its entirety.

In an embodiment, an energy production analysis may be performed on data and energy production estimates derived from the solar energy simulation. A levelized cost of energy may be determined for the life of the solar energy system or another period of time based on the energy production estimates and expected cost of conventional electricity. Conventional electricity costs may be calculated based on average electricity costs in one or more regions, adjusted based on an estimated rate of energy inflation. A total monthly or overall cost for a solar energy offering may then be computed based on the levelized cost of energy for solar and the expected conventional electricity costs. In an embodiment, the total cost of the solar energy offering may include both solar energy costs and supplemental conventional electricity costs (e.g., the amount of energy needed in addition to solar energy production). Supplemental conventional electricity costs may be calculated as a proportion of the expected cost of conventional electricity for the additional amount of energy needed.

In an embodiment, the levelized cost of energy for the solar energy system may take into account federal and/or local incentives, such as solar alternative energy credits. For example, the solar energy system may generate renewable energy credits based on an amount of carbon dioxide equivalent (CO₂e) emissions reduced. In a non-limiting example, energy produced by the solar energy system may be registered with an appropriate registry in exchange for Solar Renewable Energy Certificates (SRECs), which can then be sold to offset costs of solar energy. The expected revenue generated from selling SRECs over a period of time may be factored into the calculated levelized cost of energy. One of skill in the art will recognize that other forms of renewable energy credits may be acquired via energy produced by the solar energy system, such as but not limited to, Verified Carbon Units (VCUs).

In an embodiment, the summary results of the solar energy simulation and energy production analysis may be presented to a user of the marketplace in a comparison table. The offerings may be compared to average conventional electricity costs without solar, based on the estimated rate of energy inflation. This may inform a user of the savings achieved by installing a solar energy system. A user of the marketplace may also manually enter the amount of their average monthly electricity bill and their conventional electricity provider to re-compute comparison data.

According to an embodiment, conventional electricity information presented to the user may include the average estimated monthly electricity bill during a period of time, e.g., the average monthly bill over the course of the next 25 years if a solar energy system is not installed, based on the estimated energy inflation rate. The expected annual energy inflation rate for a region may also be presented, which may be estimated through historical data retrieved from an external third-party, such as the Energy Information Administration. Information presented may additionally include the total cost of electricity during a period of time, e.g., during the next 25 years, based on current conventional electricity bills and estimated energy inflation rates.

Each solar energy offering may be compared against the option of using only conventional electricity (e.g., not installing solar) or against another competitive offering. Each offering, for example, may display metrics unique to the offering, such as but not limited to, the new estimated monthly energy bill, the monthly savings compared to conventional electricity, the total savings compared to conventional electricity during a period of time, e.g., during a 25 year period or during the term of a lease or PPA, and the amount of initial cash outlay required to install the solar energy system.

Additional details of the offering may also be presented, such as but not limited to, the financing company (if any), the equipment type, the origin of the equipment, the installer, and the time frame of a promotion.

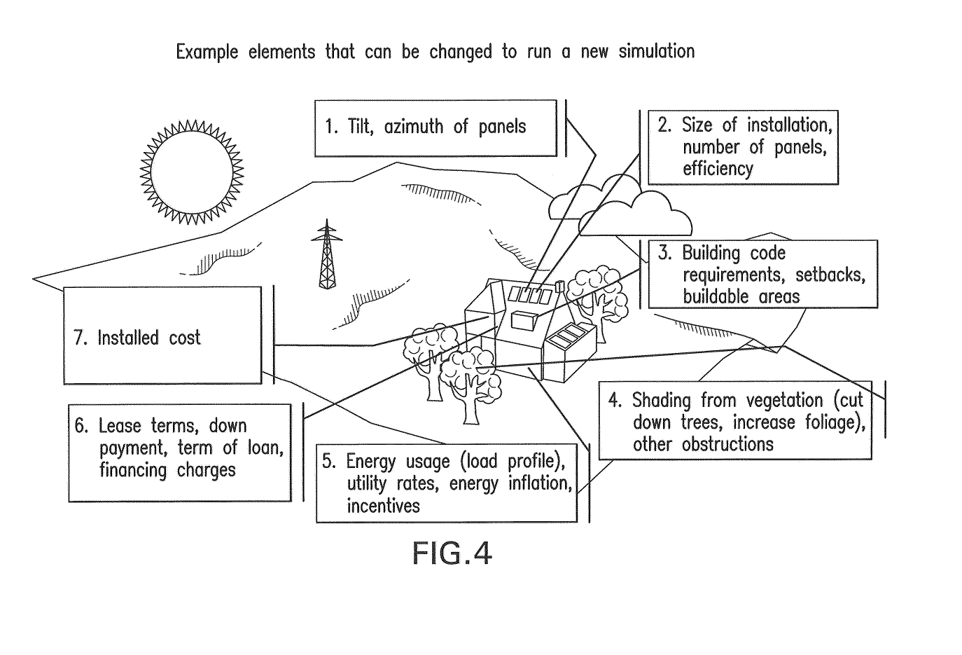

FIG. 4 is a diagram illustrating elements that may be altered when running a new simulation, according to an embodiment. In an embodiment, it may be desirable to change certain aspects of the offering or the property in order to compare results of offerings based different simulations. Changes may be manually prompted by a user, or multiple simulations may be automatically run based on common or expected feature variations.

As depicted in FIG. 4, example elements that may be changed when running new simulations include, but are not limited to, tilt and azimuth of solar panels, size of installations, number and efficiency of panels, building code requirements, setbacks, buildable areas, shading from vegetation (for example, a user may decide to cut down a tree or increase foliage), energy usage (e.g., load profile), utility rates, energy inflation, available or applicable incentives, lease terms, down payment, term of loan, financing charges, and installed cost. Installed cost may be particularly important for a cash sale, in which the property owner may only have a certain amount of money to invest. In an embodiment, if the installed cost is changed by a user, the system size and other elements may be automatically changed to reflect the adjusted cost. In an embodiment, the current amount of the property owner's monthly utility bill and the utility provider may also be changed.

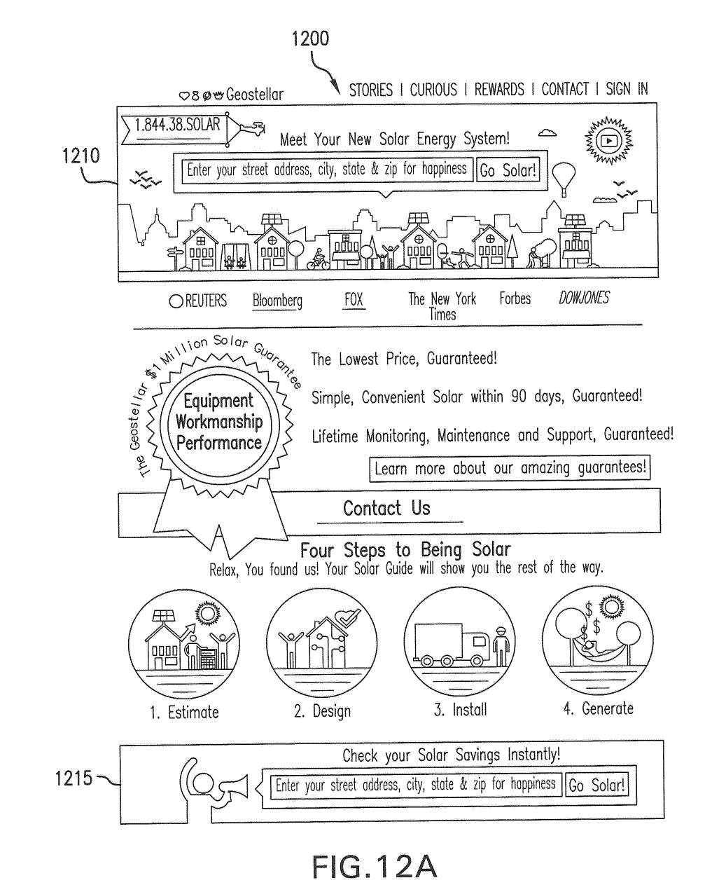

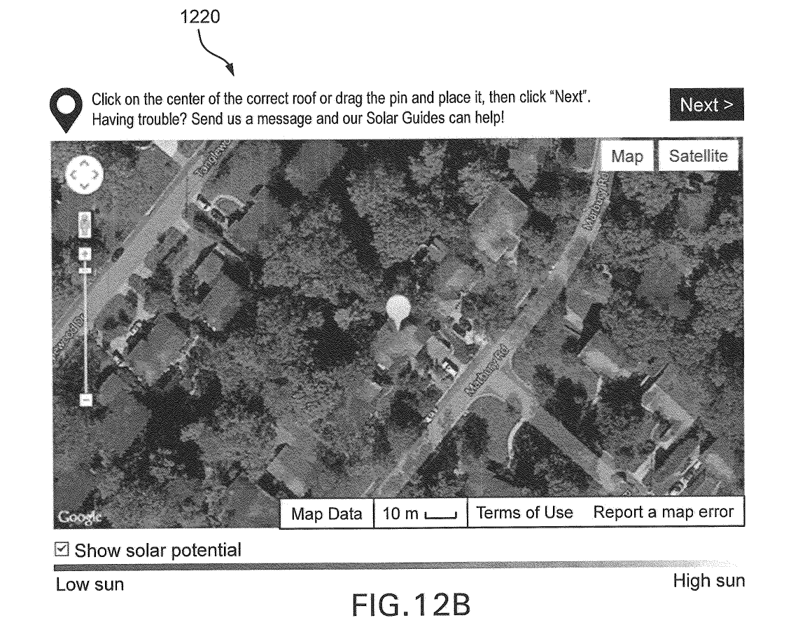

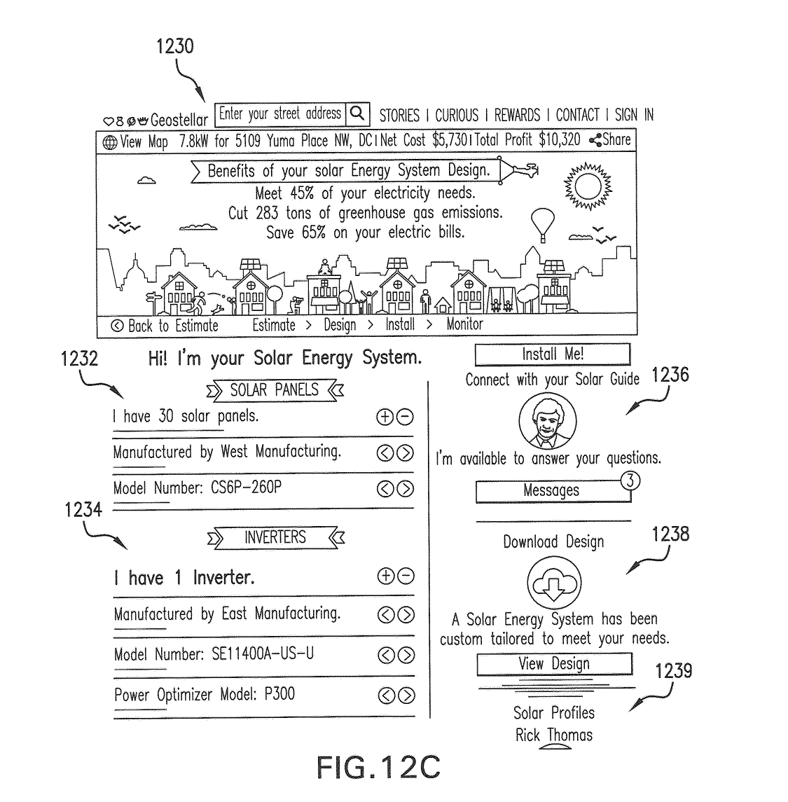

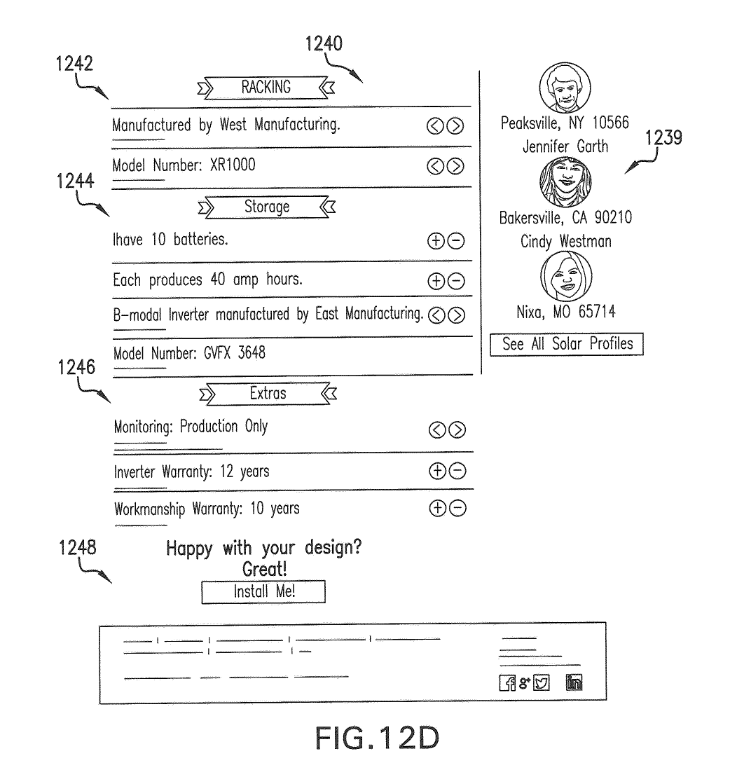

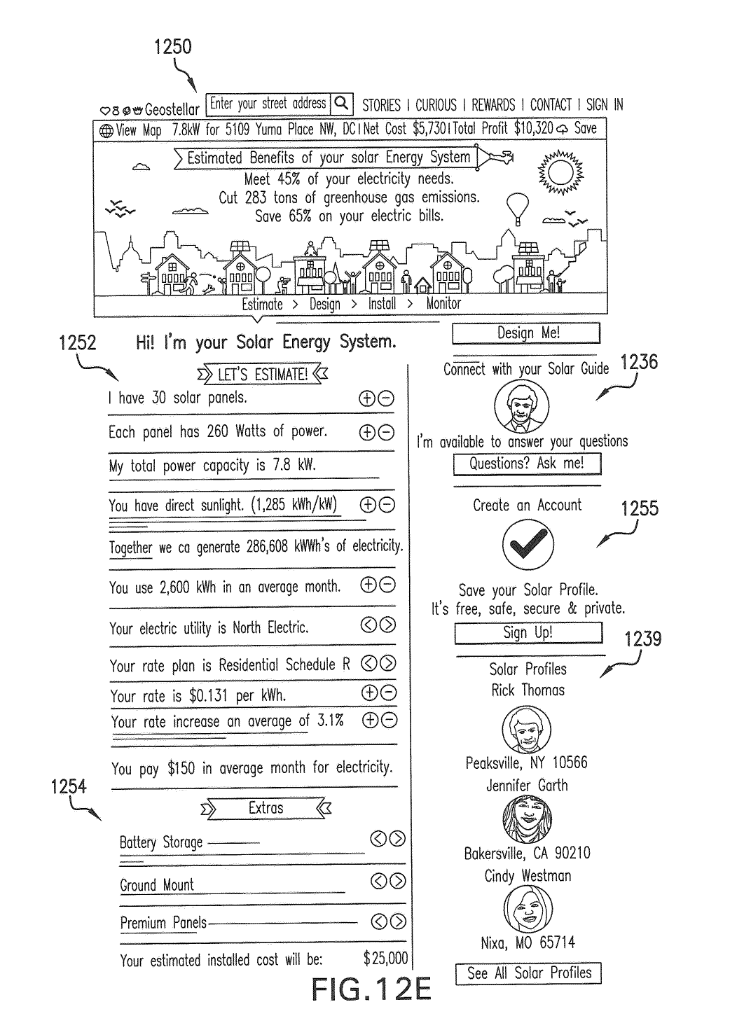

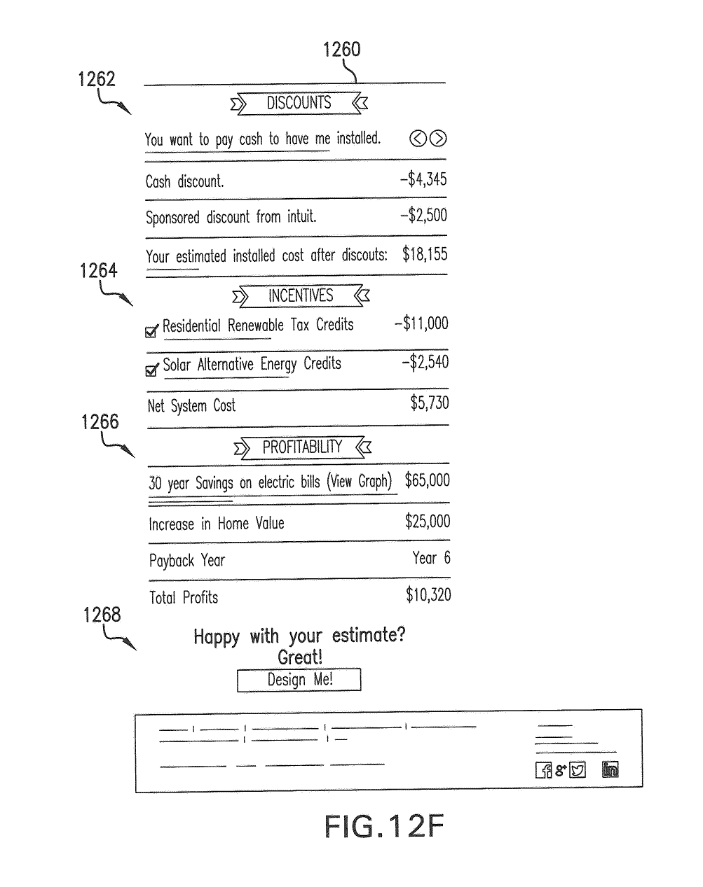

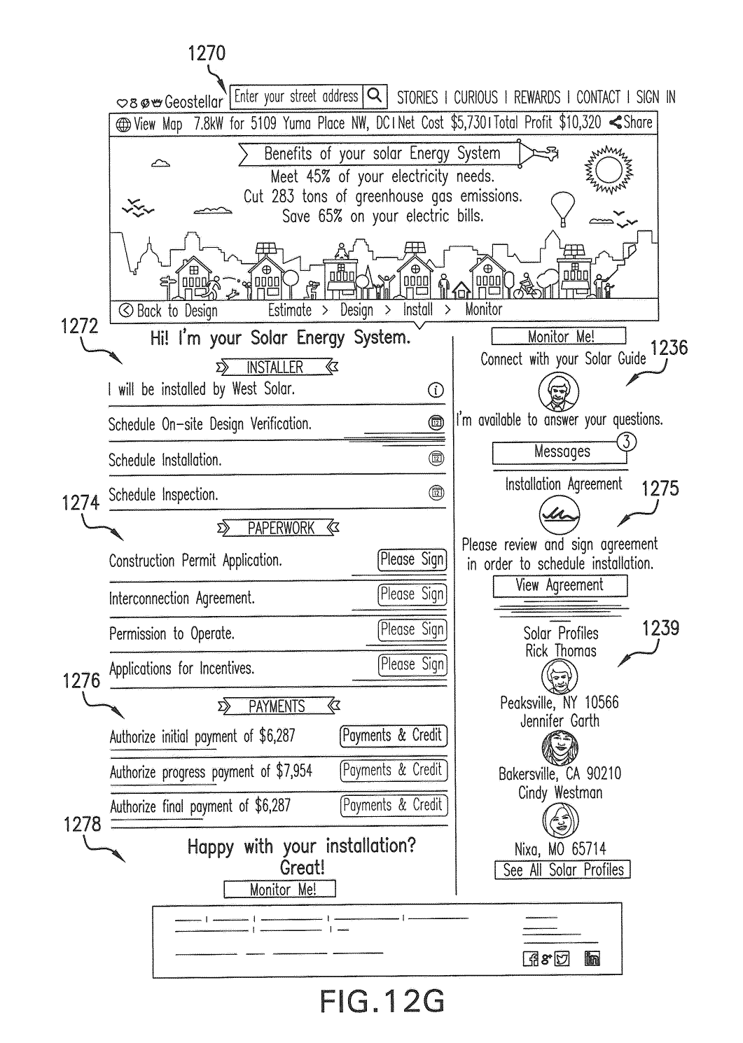

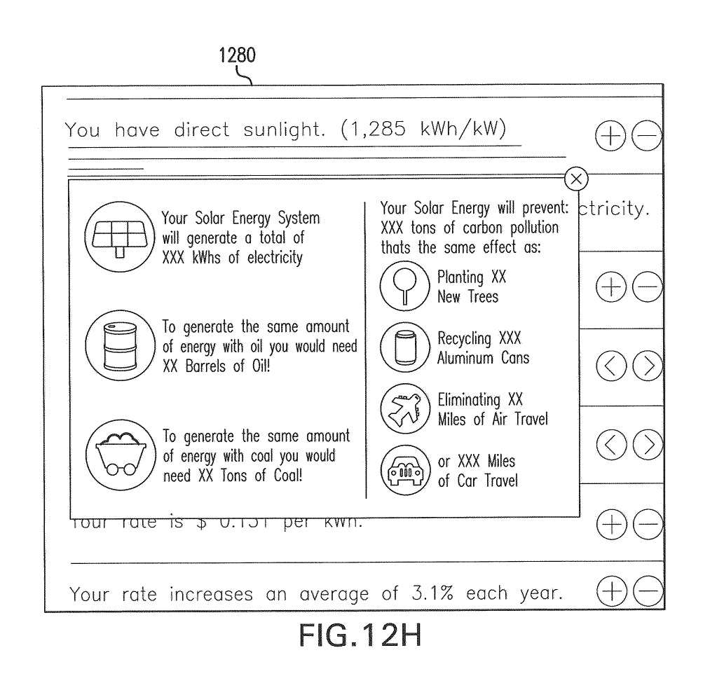

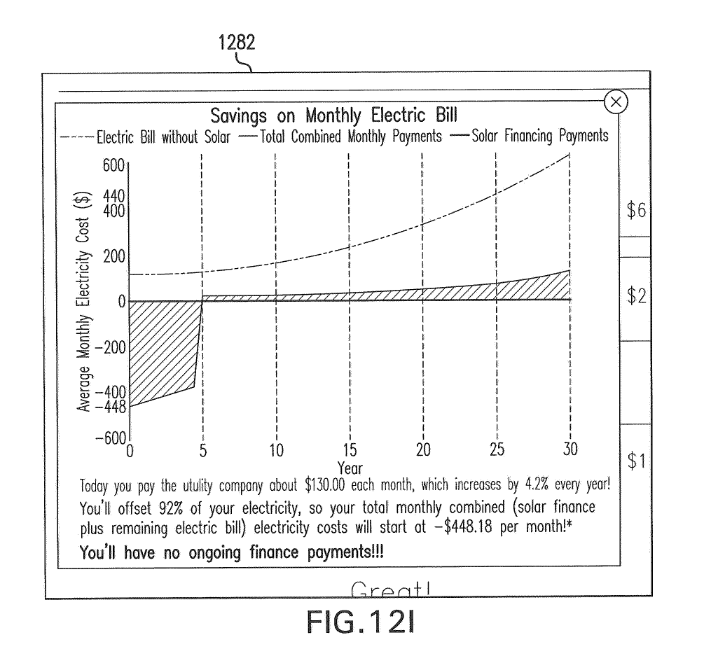

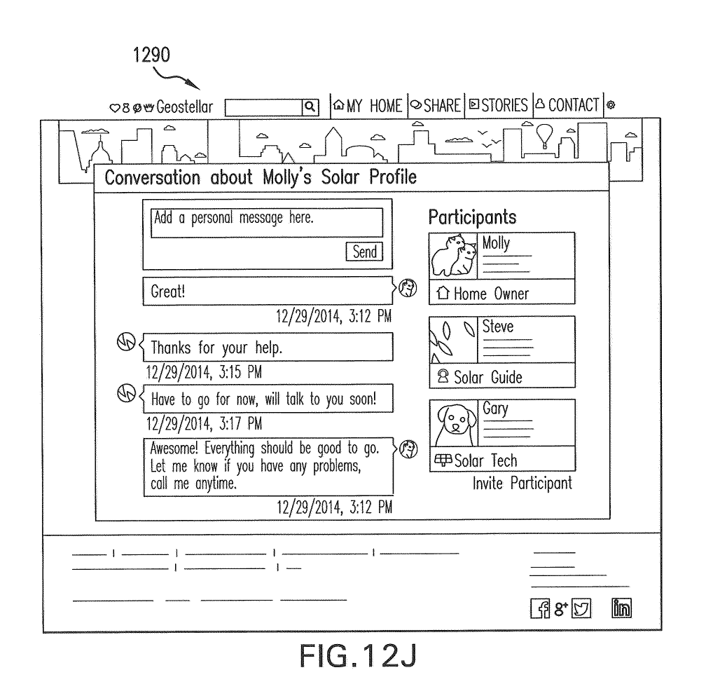

These alterations and customizations may generate new offering results. Once the modifications are made and new results are produced, the details and or summary of the offering may then be compared with other offerings and with the conventional electricity (e.g., “without solar”) option. In an embodiment, information on monthly payments, the payback period and rate, monthly savings, incentives, carbon reduction and other factors may be presented. In an embodiment, a partial list of details for the initial offerings and customized offerings that are presented to a user may include, but are not limited to: The average price of a kWh of conventional electricity for the property over the next 25 years (e.g., the life of a solar panel) or another period of time, average monthly payments for conventional electricity, the estimated annual increase in conventional electricity rates, the average cost of a kWh of solar electricity produced by the solar panels over the 25 year life of the panels accounting for degradation and other factors, average monthly financing payments for the solar energy system, the annual increase of solar energy costs (e.g., in the case of a lease with an escalator clause), the total cost of the solar energy system (including financing charges, if any), the down payment due on a lease or loan, the term of a loan, the interest rate of a loan, the percentage of the electricity bill offset by solar energy, the total monthly payments during a period of time (e.g., solar and conventional utility costs combined), the total savings for the offering as compared against conventional electricity costs, the total electricity costs over the 25 year life of the solar panels or the term of a lease or PPA (e.g., solar and conventional utility costs combined), payments due over the life of the solar energy system, such as upfront payments, loan payments and lease payments, applicable national, state, local and rate-payer incentives, such as rebates, tax credits and performance-based incentives, and the installed cost as described above with respect to FIG. 12.

The system size/capacity (nominal system power) in kW and energy production over a period of time (e.g., 25 years) in kWh or MWh may also be presented. In an embodiment, carbon pollution offset by the solar energy system, shown in barrels of tons of coal, or another metric, may additionally be presented. The effect of solar energy in offsetting carbon dioxide equivalent emissions may be equated to, for example, the number of new trees that would need to be planted, aluminum cans that would need to be recycled, miles of air travel offset, or miles of car travel offset for comparison purposes. In various embodiments, these details may be presented as lists, tables, graphs, or any combination thereof.

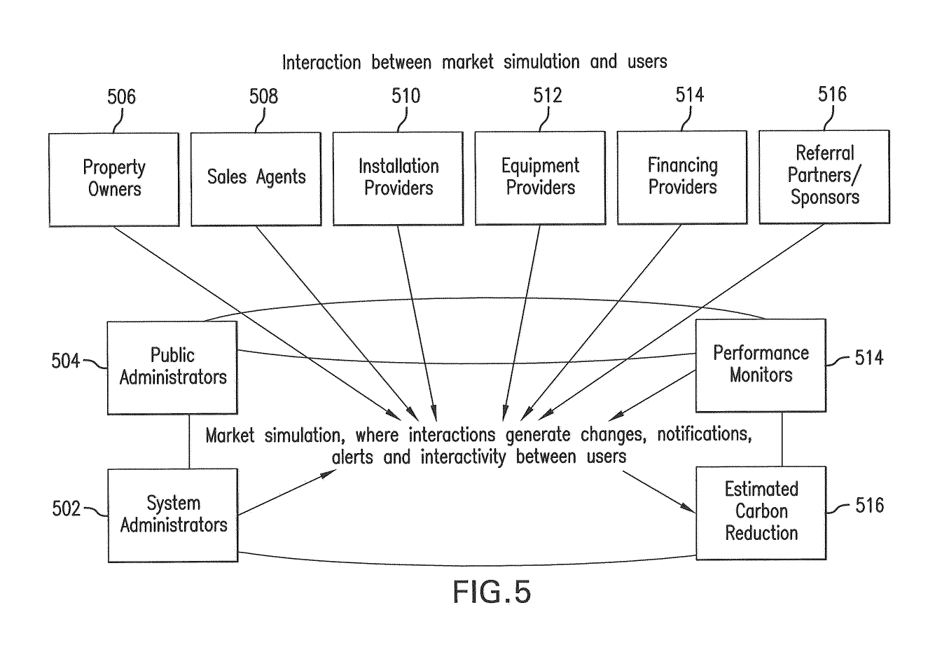

FIG. 5 is a diagram illustrating interaction between users collaborating on a solar energy simulation, according to an embodiment. During the sales and marketing process, during closing and contracting, permitting and installation, and during ongoing monitoring and maintenance, solar energy offerings and simulations in the online solar marketplace provide a communications vehicle.

In an embodiment, the online solar marketplace may include several user types, such as but not limited to, system administrators 502, public administrators 504, property owners 506, sales agents 508, solar providers 510, and referral partners and sponsors 516. Public administrators 504 may include, for example, permitting administrators and interconnection authorities. Sales agent 508 may include, for example, remote sales agents and field sales agents. Installation providers 510, equipment providers 512, and financing providers 514 may provide various installation, equipment, and financing offerings to the marketplace that may be used to perform solar energy simulations, as described previously.

In various embodiments, users may initiate and participate in dialogues within the marketplace, share documents, and link to documents and messaging systems outside the marketplace, including affixing electronic signatures on documents to close sales in the marketplace. In an embodiment, threaded dialogues may be maintained.

Alerts and notifications may also be generated by activities of other users or changes to a simulation. In an embodiment, relevant parties may be automatically notified through electronic communications when appropriate based on a user's actions, or through specific input requests. Aggregated information related to user behavior may also be collected for analytic purposes.

Once a system is commissioned, the solar panels and other appliances may be attached to communicate data to the online solar marketplace to inform installers, sales agents and property owners on their working condition, and to compare performance with other users and connected systems. The marketplace may implement various performance monitors 518 to track performance of each installed solar energy system.

In an embodiment, the estimated carbon equivalent (CO₂e) reduction 520 attributed to a solar energy offering may be calculated based on each simulation. This estimate may be used by property owners when selecting an offering, or by sponsors to evaluate carbon reduction efforts.

The marketplace may estimate the amount of CO₂e reduction for a particular solar energy offering based on the total amount of energy produced over a period of time. For example, a 10 kW solar energy system at a particular geolocation may produce approximately 100,000 kWh of energy over 10 years. The estimated energy production may be derived from one or more simulations run for the 10 kW system.

In an embodiment, the geolocation of the solar energy system may be mapped to state and/or county Federal Information Processing Standard (MPS) codes. These codes may then be correlated to data in a carbon footprinting database that contains emissions data for particular geographic regions. The estimated energy output of the solar energy system may be converted to an amount of CO₂e offset based on data retrieved from the carbon footprinting database. For example, the Environmental Protection Agency maintains an Emissions & Generation. Resource Integrated Database (eGRID), which contains emissions and energy conversion information for particular geographic regions. In an embodiment, a FIPS code mapped from the geolocation of the solar energy system may be correlated to a region defined by eGRID. The estimated solar energy output (e.g., 100,000 kWh) may then be converted into metric tons of CO₂e using conversion information retrieved from eGRID. This allows the marketplace to present an estimate of the CO₂e reduction that will be produced by installing a solar energy system at a particular geolocation.

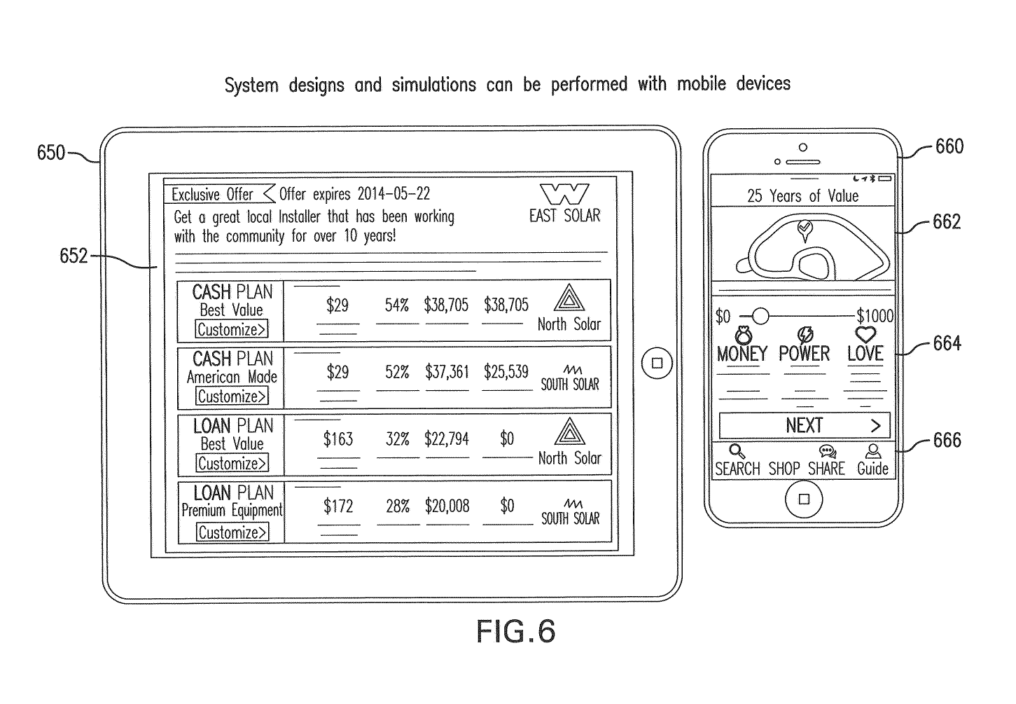

FIG. 6 is a diagram that illustrates two example displays of information on a tablet device 650 and mobile phone device 660 based on output from an online energy marketplace according to an embodiment. Display 652 in device 650 shows different financing options (e.g., a cash plan and a loan plan) provided by two different installers. Customize buttons are provided to allow a user to further input data to customize a particular plan through the online solar marketplace.

Display 662 in device 660 three panels or areas 662, 664, and 666. Panel 662 provides a display area for a map display of a particular property being simulated in the online solar marketplace for a solar installation offering. Panel 664 includes display simulation results in several ways according to a feature. First a current average electrical bill value is displayed alongside a slider for enabling a user to change the value over a range of values by moving the slider setting. Three areas for displaying data relating to Money (value of energy, total incentives), Power (system size, electric usage offset), and Love (carbon reduction equivalent in CO2 lbs and miles driven in a car). A navigation bar 666 allows further navigation to a different window.

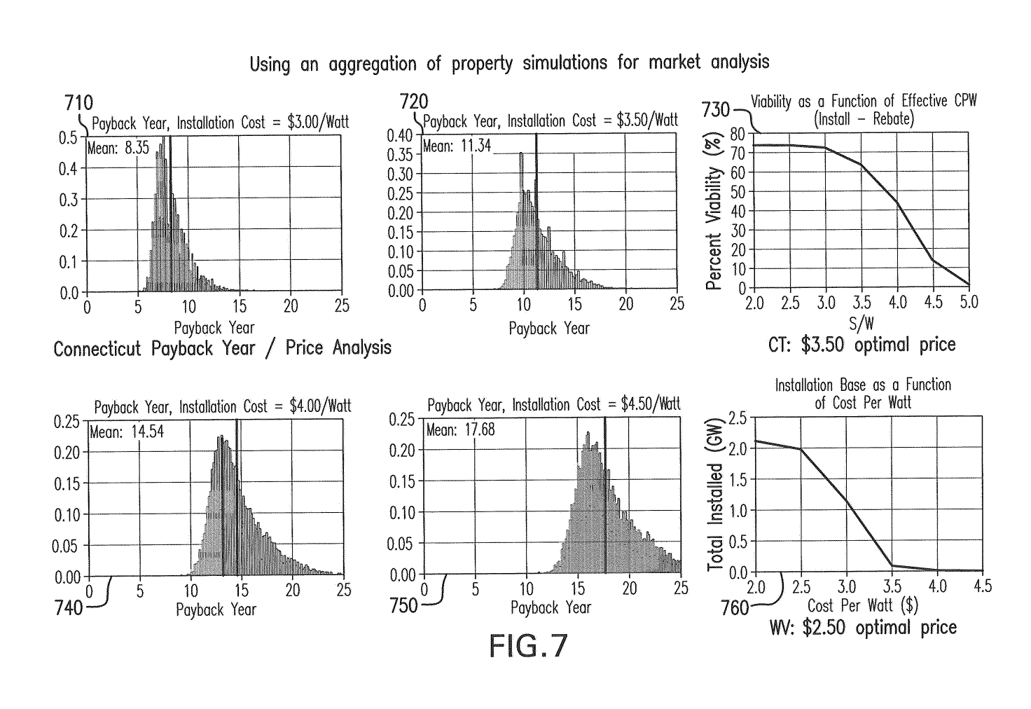

FIG. 7 is a diagram illustrating market analysis based on market simulations of particular geopolitical regions, according to an embodiment. In the examples here the top row shows three graphs of simulation results for a region in Connecticut (710, 720, 730), while the bottom row of graphs shows three graphs of simulation results for a region in West Virginia (740, 750, 760). Graph 710 shows a bar graph plot of the payback years for a normalized number of property simulations. Graph 710 shows a mean payback year of 8.35 years (from time of installation to time when all installation costs equal energy cost savings) when installation cost is $3.00/watt). Graph 720 shows the plot of the payback years for the same normalized number of property simulations of graph 710 when the cost installation is $3.50/Watt which lengthens the mean payback year to 11.34 years in the Connecticut region. Graph 730 is a line graph plot that shows the percent of properties viable for a solar installation as a function of effective cost per watt (CPW), which accounts for total installed costs less any rebates. In this example, the viability is over 60% for costs per Watt more than $3.50, which indicates one optimal price may be $3.50/Watt.

Graph 740 shows a bar graph plot of the payback years for a normalized number of property simulations in a West Virginia (WV) region. Graph 740 shows a mean payback year of 14.54 years (from time of installation to time when all installation costs equal energy cost savings) when installation cost is $4.00/watt). Graph 750 shows the plot of the payback years for the same normalized number of property simulations of graph 740 when the cost installation is $4.50/Watt which lengthens the mean payback year to 17.68 years in the WV region. Graph 760 is a line graph plot that shows the total amount of gigawatts likely to be viably installed for the region properties as a function of cost per watt (CPW) which accounts for installation costs. In this example, the installed amount drops at a greater rate for costs per Watt over $2.50, which indicates one optimal price may be $2.50/Watt.

### Example Method

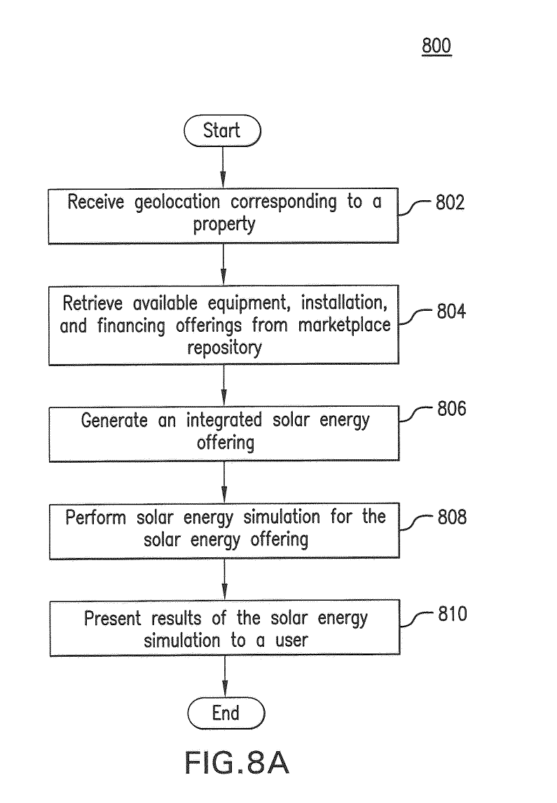

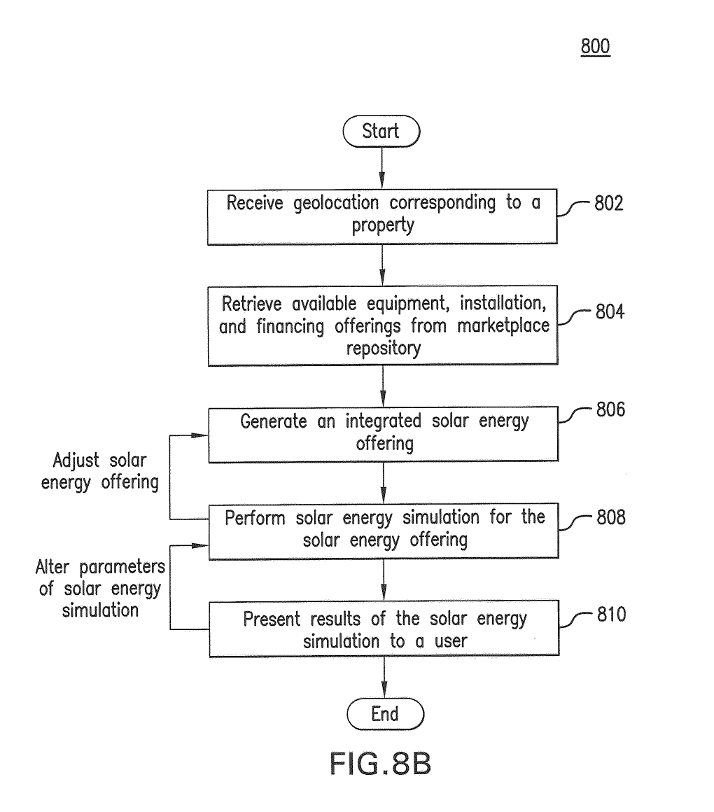

FIGS. 8A and 8B are example methods for presenting a solar energy offering to a user of a solar energy marketplace, according to an embodiment. Method 800 begins at step 802 by receiving a geolocation corresponding to a property. In an embodiment, the geolocation may be entered manually by a user of the marketplace, for example, in the form of a postal address. In various embodiments, the geolocation may be determined automatically via a user device, for example, by location data taken from a mobile device.

At step 804, available equipment, installation, and financing offerings may be retrieved from a marketplace repository, such as marketplace repository 940 of FIG. 9. In an embodiment, marketplace repository may store a plurality of service and equipment offerings from one or more equipment providers, installation providers, and financing providers, as described with respect to FIGS. 1 and 2. Available offerings may be determined by the received geolocation. For example, an installation provider may only service a particular geographic region, or certain equipment promotions may only apply to specific properties. In an embodiment, an interface may be provided interface for providers to enter and update service and equipment offerings, for example via a graphical user interface or application programming interface (API).

At step 806, an integrated solar energy offering for the property is generated based on the retrieved equipment, installation, and financing offerings. This offering may be assembled taking into account characteristics of the property and authorized combinations of equipment, installation, and financing, as described with respect to FIG. 1. The offering may be priced according to a pricing model, such as described above with respect to FIG. 2. In an embodiment, the cost of the offering may be normalized based on the capacity/size of the solar array specified in the solar energy offering.

At step 808, a solar energy simulation may be performed for the solar energy offering in order to estimate solar energy production over a given time period. For example, it may be useful to estimate solar energy production during the next 25 years, as this time period may represent the expected life of solar modules in the solar array. In an embodiment, multiple simulations may be performed by altering one or more parameters of the simulation, as described with respect to FIGS. 3 and 4. For example, atmospheric conditions or physical obstructions (e.g., trees and other vegetation), may be modified in each simulation. The results of each simulation may then be aggregated or averaged in order to improve energy production estimates. In an embodiment, energy production analysis may be performed based on the energy production estimates to determine a levelized cost of energy for solar and overall energy costs, as described with respect to FIG. 3.

At step 810, the solar energy offering and simulation results, such as energy production estimates, may be presented to the user. In an embodiment, the solar energy offering may be compared to conventional electricity options so that the user may directly compare the value of the solar energy offering. In an embodiment, the presentation of results may be constructed at a server, such as server 1010 of FIG. 10, and rendered at a client, such as client 1002, of FIG. 10.

In an embodiment, the solar energy offering may be modified, or new offerings may be created, based on results of additional simulations and energy production analysis. As illustrated in FIG. 8B, parameters for the solar energy simulation may be altered and a second solar energy simulation may be performed based on the altered parameters. For example, parameters such as, but not limited to, tilt and azimuth of solar panels, size of installations, number and efficiency of panels, building code requirements, setbacks, buildable areas, shading from vegetation (for example, a user may decide to cut down a tree or increase foliage), energy usage (e.g., load profile), utility rates, energy inflation, available or applicable incentives, lease terms, down payment, term of loan, financing charges, and installed cost may be altered for a solar energy simulation, as described with respect to FIG. 4. In various embodiments, alterations may be input by a user or determined automatically. The solar energy offering may then be adjusted based on the results of the second solar energy simulation. For example, results and analysis of the second energy simulation may indicate that optimal energy production and costs may be achieved by increasing the number of solar modules in the solar energy offering. In this manner, the offerings are intended to reflect the best value and performance based on multiple scenarios. The modified solar energy offering and simulation results may then be presented to the user.

Broad market simulations may be generated by running simulations on a plurality of properties within a particular geographic or geopolitical region and may be used in a number of ways. For example, in an embodiment, the online solar marketplace may enable users to rank and sort properties within a region, or rank and sort regions, according to solar energy capacity. These rankings may be adjusted based on determined propensities to adopt solar energy in order to rank and sort property owners and populations according to overall solar market opportunity. In an embodiment, the propensity to adopt solar may be determined by, for example, credit scores, consumer behavior, consumer demographics, political views, and real estate values.

FIG. 9 illustrates an example method for ranking, sorting and analyzing individual properties within a geographic or geopolitical region, according to an embodiment. Method 900 begins at step 902 by performing a solar energy simulation on each property within the region to determine the levelized cost of energy (LCOE) for a period of time (e.g., 25 years). At step 904, an economic or energy metric may be selected to perform the ranking of the individual properties. An example metric may be based on solar energy production potential at a particular property using factors such as shadow, slope, and orientation of available roof facets, as well as total buildable area. Another example metric may be based on economic models used to estimate an internal rate of return (IRR), net present value, and total savings for a potential solar energy installation at the property. In this example, IRR, net present value, and savings may be estimated by comparing the determined LCOE to the cost of conventional electricity.

At step 906, the individual properties within the region may be ranked according to the selected metric. At step 908, the rankings may be adjusted based on determined propensities to adopt solar energy at each property in order to rank properties according to highest solar energy conversion potential.

In addition to ranking and analyzing individual properties within a region, geopolitical regions, such as zip codes, municipalities, counties, states, and countries, may be analyzed to determine solar capacity and solar adoption propensity through a sampling or census of individual properties.

In an embodiment, the LCOE may be first characterized for each property within the sample or census based on atmospherics, shadow, slope and orientation. The cost of solar may then be characterized for each property based on conventional electricity rates, load profiles, utility inflation rates and available incentives, compared with LCOE in the region. A demonstrative solar site may be placed in the region, the specifics of which (e.g., size) may be based upon common or notional solar buyer behavior. In an embodiment, economic metrics may be determined and selected through economic modeling performed on each property. Economic metrics may include, but are not limited to, specific site performance measures (e.g., IRR), or measures which aggregate for all sites in a region, for example but not limited to, system savings multiplied by the number of potential residential or business sites. Regions may be ranked and sorted based upon the selected metric, such as an aggregate IRR for each property within the sample or census. Elements of the simulations on individual properties may be modified to determine the total addressable market under various scenarios. For example, simulations may be run with different incentives, utility rates, and/or financing options.

### Example System

FIG. 10 is a diagram illustrating an example system 1000 for providing a solar energy marketplace, according to an embodiment. System 1000 includes a client 1002 and a server 1010 connected by one or more networks 1004, such as the Internet. Server 1010 is also coupled to a geomatics data repository 1030 and marketplace repository 1040.

Client 1002 may, for example, include a web browser that enables a user to interact with a solar energy Marketplace. The web browser may respond to user input by sending a hypertext transfer protocol (HTTP) request to server 1010 via network 1004. In another example, the user may interface with client 1002 through a native application instead of a web browser, such that the native application communicates with server 1010. Client 1002 may be any type of computing device, such as and without limitation, a personal computer (PC), laptop, or mobile device.

In an embodiment, server 1010 includes data collection module 1012, simulation module 1014, pricing module 1016, incentives module 1018, query module 1020, update module 1022, and interface module 1024. Data collection module 1012 may construct a property model as described with respect to FIG. 2 in order to collect various environmental and structural data about the property. Such data may include, but is not limited to latitude and atmospheric conditions, roof shadows, slope and orientation, buildable area, setbacks, and obstructions. This data may be stored in geomatics repository 1030 for use by simulation module 1014.

In an embodiment, simulation module 1014 may run solar energy simulations and perform energy production analysis as described with respect to FIGS. 3 and 4. Results from a simulation and energy production analysis may be stored in marketplace repository 1040. Simulation module 1014 may also aggregate simulation results from a plurality of simulations and facilitate collaboration of users around a simulation.

In an embodiment, pricing module 1016 may enable pricing information to be entered into the marketplace by a plurality of solar energy providers. In a further embodiment, the marketplace may implement a bidding system for solar energy offerings, and prices may differ between offerings based on entered bids. Pricing module 1016 may also calculate total cost and normalized cost per Watt for a solar energy offering, as described with respect to FIG. 2. In an embodiment, entered prices and calculated costs may be stored in marketplace repository 1040.

In an embodiment, incentives module 1018 may apply discounts, promotions, rebates, federal incentives, and/or local incentives to installation and energy costs of a solar energy offering. In a further embodiment, pricing module 1016 may use information from incentives module 1018 to adjust calculated costs for a solar energy offering. In various embodiments, incentives module 1018 may enable a user to enter discounts, promotions, rebates, or incentives in the online solar marketplace, and/or incentives module 1018 may retrieve this information from a third-party via a network.

In an embodiment, query module 1020 may retrieve data from geomatics repository 1030 for use by simulation module 1014 in running solar energy simulations. Query module 1020 may also retrieve data from marketplace repository upon request by any of the modules of server 1010. In an embodiment, update module 1022 may be responsible for writing data to geomatics repository 1030 and marketplace repository 1040.

In an embodiment, interface module 1024 may present marketplace data to client 1002 via network 1004. In an embodiment, an interface for presentation may be constructed at server 1010 and rendered at client 1002. Example interfaces are discussed with respect to FIGS. 12-15.

Geomatics repository 1030 may store data related to a plurality of properties collected by data collection module 1012, including collected environmental and structural data. Geomatics repository 1030 may be any type of structured data store, including a relational or document-oriented database, such as an SQL-compatible database.

Geomatics repository 1030 may store data in a plurality of different data tables 1034A, B, etc. To improve performance of database queries and updates, geomatics repository 1030 may also include an index table 1032. In an embodiment, update module 1022 queries index table 1032 to assist with data insertions and updates, and query module 1020 queries index table 1032 to assist with data retrieval. In an embodiment, the index table 1032 may point to entries in data tables 1034, which include complete data records. Or, in an embodiment where the database is de-normalized, the index table may itself include individual data records in par or in full. In this way, index table 1032 may be used to improve performance of database queries and updates.

Marketplace repository 1040 may store various marketplace data, such as but not limited to, simulation data, pricing data, user data, and performance data. Marketplace repository 1040 may be any type of structured data store, including a relational or document-oriented database, such as an SQL-compatible database.

Marketplace repository 1040 may store data in a plurality of different data tables 1044A, B, etc. To improve performance of database queries and updates, marketplace repository 1040 may also include an index table 1042. In an embodiment, update module 1022 queries index table 1042 to assist with data insertions and updates, and query module 1020 queries index table 1042 to assist with data retrieval. In an embodiment, the index table 1042 may point to entries in data tables 1044, which include complete data records. Or, in an embodiment where the database is de-normalized, the index table may itself include individual data records in part or in full. In this way, index table 1042 may be used to improve performance of database queries and updates.

In an embodiment, data in geomatics repository 1030 and marketplace repository 1040 may be accessed via an application programming interface (API). In this manner, the API may allow third party applications to, for example, analyze simulation data and monitor performance of solar energy systems.

Server 1010 and its example constituent modules 1012-1024 in FIG. 10 may be implemented on the same or different computing systems having server functionality, in hardware, software, or any combination thereof. Such computing systems may include, but are not limited to, a personal computer, a mobile device such as a mobile phone, workstation, embedded system, game console, television, set-top box, or any other computing device. Further, a computing system may include, but is not limited to, a device having a processor and memory, including a nontransitory memory, for executing and storing instructions. The memory may tangibly embody the data and program instructions. Software may include one or more applications and an operating system. Hardware may include, but is not limited to, a processor, memory, and graphical user interface display. The computing system may also have multiple processors and multiple shared or separate memory components. For example, the computing system may be a part of or the entirety of a clustered computing environment or server farm. Geomatics repository 1030 and marketplace repository 1040 may be implemented on the same or different computing systems. In an embodiment, the repositories may be part of the same or separate database instances.

### Example Computer System

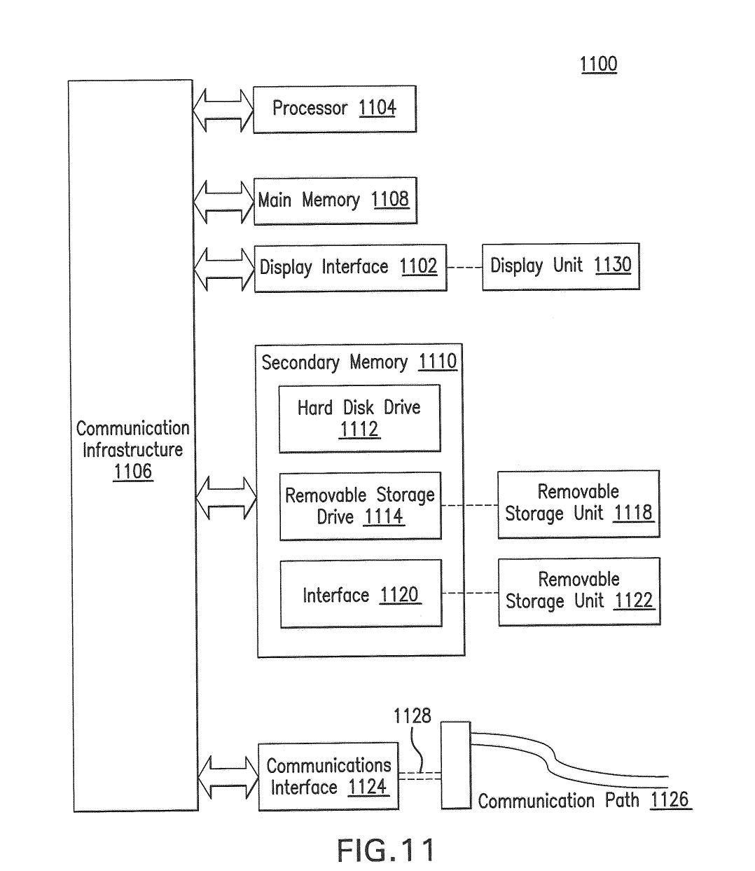

FIG. 11 is an example computing system useful for implementing various embodiments. Various embodiments can be implemented, for example, using one or more well-known computer systems, such as computer system 1100. Computer system 1100 can be any well-known computer capable of performing the functions described herein, such as computers available from International Business Machines, Apple, Sun, HP, Dell, Sony, Toshiba, etc.

Computer system 1100 includes one or more processors (also called central processing units, or CPUs), such as a processor 1104. Processor 1104 may be connected to a communication infrastructure or bus 1106.

One or more processors 1104 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 1100 also includes user input/output device(s) 1103, such as monitors, keyboards, pointing devices, etc., which communicate with communication infrastructure 110 through user input/output interface(s) 1102.

Computer system 1100 also includes a main or primary memory 1108, such as random access memory (RAM). Main memory 1108 may include one or more levels of cache. Main memory 1108 has stored therein control logic (i.e., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive,

Removable storage drive 1114 may interact with a removable storage unit 1118. Removable storage unit 1118 includes a computer usable or readable storage device having stored thereon computer software (control logic) and/or data. Removable storage unit 1118 may be a floppy disk, magnetic tape, compact disk, DVD, optical storage disk, and/or any other computer data storage device. Removable storage drive 1114 reads from and/or writes to removable storage unit 1118 in a well-known manner.

According to an exemplary embodiment, secondary memory 1110 may include other means, instrumentalities or other approaches for allowing computer programs and/or other instructions and/or data to be accessed by computer system 1100. Such means, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 enables computer system 1100 to communicate and interact with any combination of remote devices, remote networks, remote entities, etc. (individually and collectively referenced by reference number 1128). For example, communication interface 1124 may allow computer system 1100 to communicate with remote devices 1128 over communications path 1126, which may be wired and/or wireless, and which may include any combination of LANs, WANs, the Internet, etc. Control logic and/or data may be transmitted to and from computer 1100 via communication path 1126.

In an embodiment, a tangible apparatus or article of manufacture comprising a tangible computer useable or readable medium having control logic (software) stored thereon is also referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100), causes such data processing devices to operate as described herein.

Based on the teachings contained in this disclosure, it will be apparent to persons skilled in the relevant art(s) how to make and use the inventions using data processing devices, computer systems and/or computer architectures other than that shown in FIG. 11. In particular, embodiments may operate with software, hardware, and/or operating system implementations other than those described herein.

### Example Application of an Online Solar Energy Marketplace

FIG. 12A depicts an example interface 1200 for an online solar marketplace, according to an embodiment. Interface 1200 may include panel 1210 and panel 1215. Panels 1210 and 1215 may include search boxes that enable a user of the online solar marketplace to enter a property address or geolocation. In an embodiment, this location may be submitted to the online solar marketplace for processing in order to determine potential solar energy offerings. In an embodiment, interface 1200 may serve as a landing page for the online solar marketplace.

FIG. 12B depicts a map 1220 illustrating solar potential of a particular region, according to an embodiment. Map 1220 may be generated in response to a geolocation entered by a user, for example, in interface 1200 of FIG. 12A. In an embodiment, solar insolation potential for each property rooftop may be generated from property data collected from a data collection module, such as data collection module 1012 of FIG. 10. An interface module, such as interface module 1024 of FIG. 10, may generate and output map 1220 to a client device for display. In an embodiment, map 1220 enables a user to select a specific property in map 1220.

FIGS. 12C and 12D depict example interfaces 1230 and 1240 for viewing details of a solar energy offering, according to an embodiment. In an embodiment, interfaces 1230 and 1240 may be generated in response to a property selection in map 1220 of FIG. 12B. In another embodiment, interfaces 1230 and 1240 may be generated in response to a submitted geolocation in interface 1200 of FIG. 12A.

Interface 1230 may display details of a solar energy offering and include panels 1232, 1234, 1236, 1238, and 1239. In an embodiment, the solar energy offering may be generated as described with respect to FIGS. 1-4 and 8 by determining and comparing available equipment, installation, and financing offerings. Panel 1232 may display solar module (panel) equipment details such as, but not limited to, size of solar array, manufacturer, and model number. Panel 1234 may display inverter equipment details such as, but not limited to, number of inverters, manufacturer, model number, and power optimizer mode. In the example depicted in interface 1230, the solar energy offering includes 30 solar modules (panels) and one inverter. Panel 1236 may enable a user to connect with a solar guide for assistance with the solar energy offering. Panel 1238 may enable a user to save details of the solar energy offering to local storage. Panel 1239 may display relevant solar profiles of other users for comparison purposes. In an embodiment, a solar profile may include details of an installed solar energy system on a particular property.

Interface 1240 may display additional details of the solar energy offering and include panels 1242, 1244, 1246, and 1239. Panel 1242 may display racking equipment details such as, but not limited to, manufacturer and model number. Panel 1244 may display energy storage details such as, but not limited to, number of batteries, battery capacity, manufacturer, and model number. In an embodiment, energy storage may not be included in a solar energy offering. Panel 1246 may display details of system extras such as, but not limited to, solar energy system monitoring, equipment warranties, and installation warranties.

FIGS. 12E and 12F depict example interfaces 1250 and 1260 for entering and altering parameters of a solar energy simulation, according to an embodiment. In an embodiment, for a giver solar energy offering, one or more solar energy simulations may be performed as described with respect to FIGS. 3 and 4. Interface 1250 may include panels 1252, 1254, 1236, 1255, and 1239. Panel 1252 may display parameters for a solar energy simulation such as, but not limited to, solar array size, solar module power, calculated direct sunlight to the solar array, average conventional electricity monthly usage, current electric utility provider, current electric utility schedule, current conventional electricity rate (e.g., electricity costs per kWh), estimated conventional electricity annual rate increase, and average conventional electricity monthly cost. In an embodiment, direct sunlight may be calculated by a data collection module, such as data collection module 1012 of FIG. 10, prior to performing the solar energy simulation. Panel 1254 may display additional parameters for a solar energy simulation such as, but not limited to, battery storage, mounting options, and equipment upgrades (e.g., panel upgrades. In an embodiment, each parameter may be altered by a user interacting with interface 1250. A solar energy simulation may be run each time a parameter is altered, or manually after entering or altering one or more parameters. Panel 1255 may enable a user to create an account with the online solar marketplace in order to save details the solar energy offering, solar energy simulation parameters, and solar energy simulation results for later viewing and action.

Interface 1260 may include panels 1262, 1264, and 1266. The options displayed in panels 1262 and 1264 may reduce the installed and monthly energy costs of a solar energy offering through discounts and incentives. Panel 1262 may display financing and discount parameters for the solar energy simulation such as, but not limited to, financing type (e.g., cash, credit, lease, loan, or PPA), financing specific discounts, and promotional discounts. Panel 1264 may display incentive parameters such as, but not limited to, federal and local credits. Panel 1266 may display estimated profitability details such as, but not limited to, savings over a period of time as compared to conventional electricity, increase in property value, the year that the installed cost of the solar energy system may be paid off, and total profits due to installing the solar energy system. In the example depicted in interface 1260, the solar energy offering is estimated to save a property owner $65,000 in electric bills over a 30 year period and increase property value by approximately $25,000. In an embodiment, profitability details may be determined by performing a solar energy simulation.

FIG. 12G depicts an example interface 1270 for viewing and monitoring details of a selected solar energy system installation, according to an embodiment. Once a solar energy offering has been selected by a user, interface 1270 may aggregate installation and administrative details and provide actions to be taken by a user. Interface 1270 may include panels 1272, 1274, 1276, 1278, 1236, 1275, and 1239. Panel 1272 may display actions related to installation to be taken by a user. Panel 1274 may display paperwork required to be completed. Panel 1276 may display required payments to be made. Panel 1278 may enable a user to monitor installation and administrative details associated with the solar energy system. Panel 1275 may enable a user to view an installation agreement associated with installing the solar energy system.

FIG. 12H depicts an example interface 1280 for viewing estimated energy production of a solar energy system, according to an embodiment, interface 1280 may display results of one or more solar energy simulations run on a solar energy offering such as, but not limited to, estimated total energy produced during a period of time (e.g., 25 years), comparative requirements for energy produced from oil or coal, and carbon dioxide equivalent (CO₂e) prevention due to installation of the solar energy system specified by the solar energy offering. In an embodiment, the estimations displayed in interface 1280 may be derived as described with respect to FIGS. 1-4. In an embodiment, the estimations displayed in interface 1280 may be an average of results generated from a plurality of performed solar energy simulations with different parameters.

FIG. 12I depicts an example interface 1282 for displaying the estimated costs of solar energy compared to conventional electricity costs, according to an embodiment. The estimated costs displayed in interface 1282 may be derived from one or more solar energy simulations run on a solar energy offering. The estimated monthly costs of solar energy may factor in both installed cost and monthly energy costs of the solar energy offering, as described with respect to FIGS. 2-4. As illustrated in example interface 1282, a graph may be displayed to directly compare the monthly costs of conventional electricity against the estimated monthly costs of solar energy combined with conventional electricity. This may provide a user with a graphical representation of the monthly savings gained by installing a solar energy system. In the example depicted by interface 1282, monthly energy costs based on a particular solar energy offering are estimated to be lower than monthly conventional electricity costs.

FIG. 12J depicts an example interface for communicating among users of an online solar marketplace, according to an embodiment. Solar energy offerings and solar energy simulations may provide a communications vehicle for various users. For example, a property owner selecting a particular solar energy offering may send messages to and communicate with a representative of the installation provider. In an embodiment, a user may create a solar energy profile including a solar energy offering and one or more solar energy simulations. Conversations may then be initiated based on the solar energy offering or simulations included in the solar profile.

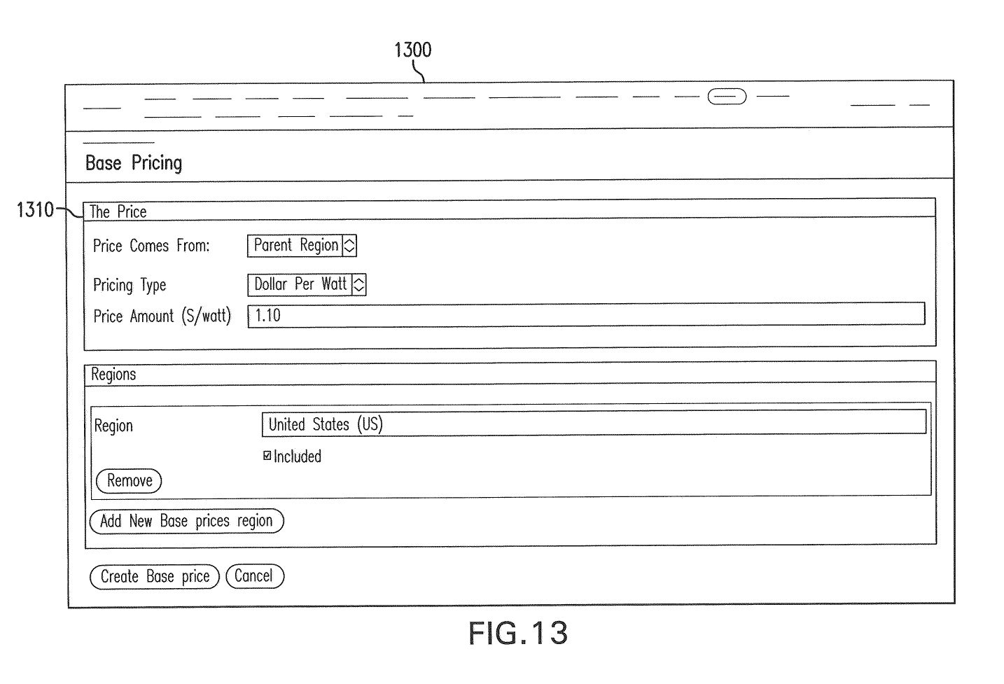

FIG. 13 depicts an example interface 1300 for entering solar energy base pricing information in an online solar marketplace, according to an embodiment. In various embodiments, interface 1300 may be presented to an end user or administrator of the online solar marketplace. Interface 1300 may include panel 1310, which may enable a user to enter estimated conventional electricity pricing information for a particular region. Panel 1310 may include fields such as, but not limited to, price source, pricing type, price amount, and region.

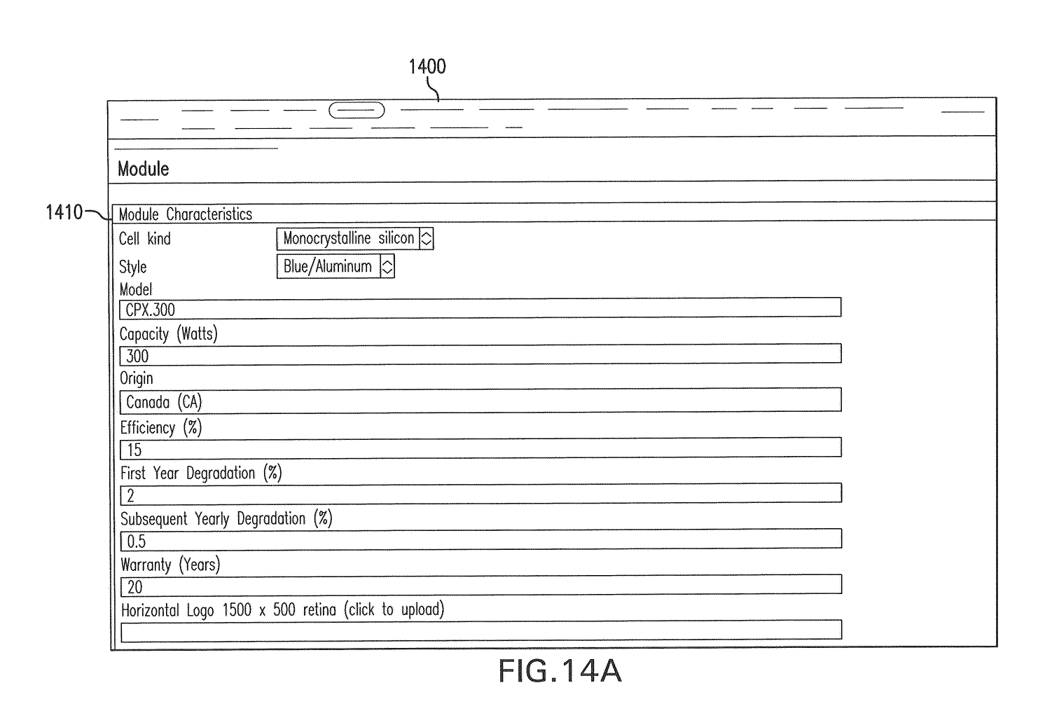

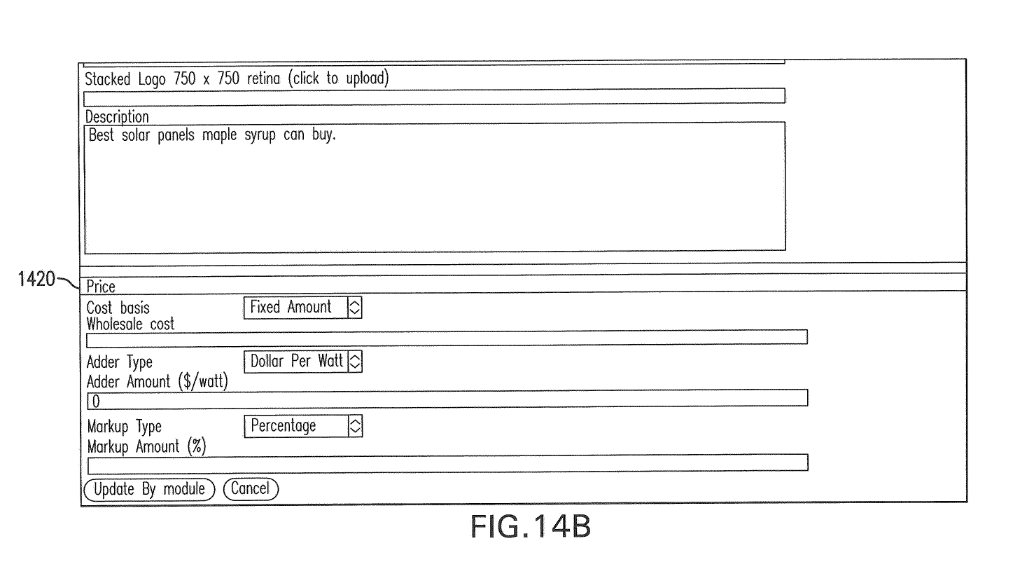

FIGS. 14A and 14B depict example interface 1400 for entering an equipment offering in an online solar marketplace, according to an embodiment. In various embodiments, interface 1400 may be presented to an equipment provider or administrator of the online solar marketplace. Interface 1400 may include panels 1410 and 1420. Panel 1410 may enable a user to enter equipment characteristics. In the example depicted in FIGS. 14A and 14B, a user may be able to enter a solar module (panel) offering. The offering may include equipment characteristics such as, but not limited to, cell type, style, model, capacity, origin, efficiency, first year degradation, subsequent yearly degradation, warranty information, a logo, a stacked logo, and a description. Panel 1420 may enable a user to enter equipment pricing information such as, but not limited to, cost basis, wholesale cost, adder type (e.g., additional cost due to an equipment upgrade), adder amount, markup type, and markup amount. Equipment offerings may be used when determining solar energy offerings, as described with respect to FIGS. 2-4 and 8.

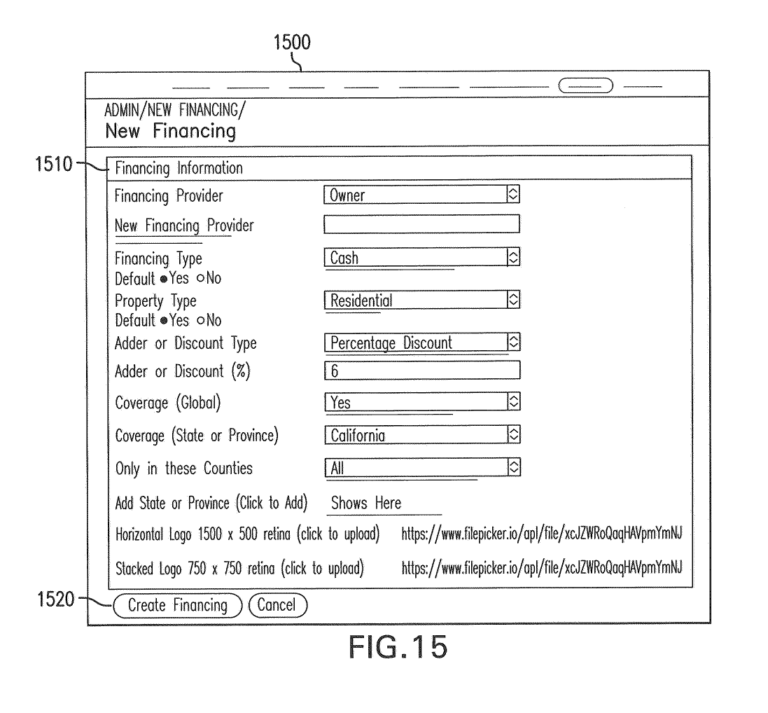

FIG. 15 depicts an example interface 1500 for entering a financing offering in ale online solar marketplace, according to an embodiment. In various embodiments, interface 1500 may be presented to a financing provider or administrator of the online solar marketplace. Interface 1500 may include panels 1510 and 1520. Panel 1510 may enable a user to enter details of a financing offering such as, but not limited to, financing provider, name of new financing provider (if required), financing type (e.g., cash, credit, lease, loan, or PPA), property type, adder or discount type, adder or discount amount, global coverage, country-specific coverage, state/province-specific coverage, a horizontal logo, and a stacked logo.

Example interface 1500 depicts a financing type of cash. In an embodiment, additional details may be entered for other financing types. For example, for lease financing, panel 1510 may display details such as, but not limited to, term of lease, description of lease, monthly price per kWh, and marketing payment. For loan financing, panel 1510 may display details such as, but not limited to, term of loan, description of loan, annual percentage rate (APR), and dealer fee. For power purchase agreements (PPAs), panel 1510 may display details such as, but not limited to, term of PPA, description of PPA, price per kWh, and marketing payment.

Panel 1520 may enable a user to submit the entered financing offering to the online marketplace. In an embodiment, this offering may be stored in a marketplace repository, such as marketplace repository 940 of FIG. 9.

### CONCLUSION

Identifiers, such as “(a),” “(b),” “(i),” “(ii),” etc., are sometimes used for different elements or steps. These identifiers are used for clarity and do not necessarily designate an order for the elements or steps.

Embodiments of the present inventions have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the inventions that others can, by applying knowledge within the skill of the art, readily modify and/or adapt for various applications such specific embodiments, without undue experimentation, without departing from the general concept of the present inventions. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present inventions should not be limited by any of the above-described embodiments, but should be defined only in accordance with the following claims and their equivalents.

What is claimed is:

1. A system for providing an online solar marketplace, comprising:
one or more computing devices;
a marketplace repository storing a plurality of service and equipment offerings from one or more equipment providers, installation providers, or financing providers;
a query module, implemented on the one or more computing devices, configured to:
receive a geolocation corresponding to a property, and
retrieve available equipment, installation, or financing offerings from the marketplace repository;
a pricing module, implemented on the one or more computing devices, configured to generate an integrated solar energy offering for the property based on the retrieved equipment, installation, or financing offerings;
a simulation module, implemented on the one or more computing devices, configured to perform a solar energy simulation for the solar energy offering to estimate energy production over a predetermined time period; and
an interface module, implemented on the one or more computing devices, configured to present the solar energy offering and energy production estimates for output over a network to a remote user.

2. The system of claim 1, wherein the query module is further configured to retrieve pricing information from the marketplace repository, and
wherein the pricing module is further configured to calculate a total installed cost for the solar energy offering based on the retrieved pricing information.

3. The system of claim 2, wherein the pricing module is further configured to normalize the calculated installed cost for the solar energy offering based on a solar array capacity specified in the solar energy offering.

4. The system of claim 1, further comprising a geomatics repository storing collected environmental and structural data related to a plurality of properties,
wherein the query module is further configured to retrieve property data based on the received geolocation from the geomatics repository, and
wherein the simulation module is further configured to perform the solar energy simulation based on the retrieved property data.

5. The system of claim 1, wherein the simulation module is further configured to estimate a levelized cost of energy for the solar energy offering during the predetermined time period based on the performed simulation.

6. The system of claim 1, wherein the simulation module is further configured to calculate supplemental conventional electricity costs during the predetermined time period based on the solar energy production estimates.

7. The system of claim 1, wherein the simulation module is further configured to:
alter one or more parameters of the solar energy simulation; and
perform a second solar energy simulation based on the altered one or more parameters;

8. The system of claim 7, wherein the pricing module is further configured to adjust the solar energy offering based on energy production estimates produced by the second solar energy simulation, and
wherein the interface module is further configured to present the adjusted solar energy offering and energy production estimates to the user.

9. The system of claim 1, wherein data produced by the solar energy simulation is accessible via an application programming interface (API).

10. The system of claim 1, further comprising an update module, implemented on the one or more computing devices, configured to write the energy production estimates to the marketplace repository.

11. A method for providing an online solar marketplace, comprising:
receiving a geolocation corresponding to a property;
retrieving available equipment, installation, and financing offerings from a marketplace repository, the marketplace repository storing a plurality of service and equipment offerings from one or more equipment providers, installation providers, or financing providers;
generating an integrated solar energy offering for the property based on the retrieved equipment, installation, or financing offerings;
performing a solar energy simulation for the solar energy offering to estimate energy production over a predetermined time period; and
presenting the solar energy offering and energy production estimates to a user.

12. The method of claim 11, further comprising:
retrieving pricing information from the marketplace repository; and
calculating a total installed cost for the solar energy offering based on the retrieved pricing information.

13. The method of claim 12, further comprising normalizing the calculated installed cost for the solar energy offering based on a solar array capacity specified in the solar energy offering.

14. The method of claim 11, wherein the performing further comprises:
retrieving property data based on the received geolocation from a geomatics repository, the geomatics repository storing collected environmental and structural data related to a plurality of properties; and
performing the solar energy simulation based on the retrieved property data.

15. The method of claim 11, wherein the performing further comprises estimating a levelized cost of energy for the solar energy offering during the predetermined time period based on the performed simulation.

16. The method of claim 11, wherein the performing further comprises calculating supplemental conventional electricity costs during the predetermined time period based on the solar energy production estimates.

17. The method of claim 11, further comprising:
altering one or more parameters of the solar energy simulation;
performing a second solar energy simulation based on the altered one or more parameters;
adjusting the solar energy offering based on energy production estimates produced by the second solar energy simulation; and
presenting the adjusted solar energy offering and energy production estimates to the user.

18. The method of claim 11, wherein data produced by the solar energy simulation is accessible via an application programming interface (API).

19. A non-transitory computer-readable storage device having instructions stored thereon that, when executed by at least one computing device, causes the at least one computing device to perform operations comprising:
receiving a geolocation corresponding to a property;
retrieving available equipment, installation, and financing offerings from a marketplace repository, the marketplace repository storing a plurality of service or equipment offerings from one or more equipment providers, installation providers, or financing providers;
generating an integrated solar energy offering for the property based on the retrieved equipment, installation, and financing offerings;
performing a solar energy simulation for the solar energy offering to estimate energy production over a predetermined time period; and
presenting the solar energy offering and energy production estimates to a user.

20. The computer-readable storage device of claim 19, further comprising:
retrieving pricing information from the marketplace repository; and
calculating a total installed cost for the solar energy offering based on the retrieved pricing information.

21. The computer-readable storage device of claim 19, wherein the performing further comprises:
retrieving property data based on the received geolocation from a geomatics repository, the geomatics repository storing collected environmental and structural data related to a plurality of properties; and
performing the solar energy simulation based on the retrieved property data.

22. The computer-readable storage device of claim 19, wherein the performing further comprises estimating a levelized cost of energy for the solar energy offering during the predetermined time period based on the performed simulation.

23. The computer-readable storage device of claim 19, wherein the performing further comprises calculating supplemental conventional electricity costs during the predetermined time period based on the solar energy production estimates.

24. The computer-readable storage device of claim 19, further comprising:
altering one or more parameters of the solar energy simulation;
performing a second solar energy simulation based on the altered one or more parameters;
adjusting the solar energy offering based on energy production estimates produced by the second solar energy simulation; and
presenting the adjusted solar energy offering and energy production estimates to the user.
